(19) United States
(12) Patent Application Publication
(10) Pub. No.: US 2013/0145572 A1
(43) Pub. Date: Jun. 13, 2013

(54) Surface Cleaning Robot

(71) Applicants: Thomas P. Schregardus, Somerville, MA (US); Michael G. Rider, Lowell, MA (US)

(72) Inventors: Thomas P. Schregardus, Somerville, MA (US); Michael G. Rider, Lowell, MA (US)

(73) Assignee: iRobot Corporation, Bedford, MA (US)

(21) Appl. No.: 13/555,387

(22) Filed: Jul. 23, 2012

Related U.S. Application Data
(60) Provisional application No. 61/512,204, filed on Jul. 27, 2011.

(51) Int. Cl. A47L 11/40

(52) U.S. Cl. CPC A47L 11/4036; A47L 11/4011; A47L 11/4044
USPC 15/319; 15/3; 15/49.1; 15/363; 15/322; 134/117; 29/458

(57) ABSTRACT

A mobile robot that includes a body, a drive system movably supporting the body above a cleaning surface, and a cleaning system arranged to clean the cleaning surface. The robot further includes a controller in communication with at least one of the drive system and the cleaning system and a super-hydrophobic coating applied to at least one of the drive system, the cleaning system, and the controller.

### CROSS REFERENCE TO RELATED APPLICATIONS

This U.S. patent application claims priority under 35 U.S.C. §119(e) to U.S. Provisional Application 61/512,204, filed on Jul. 27, 2012, which is hereby incorporated by reference in its entirety.

### TECHNICAL FIELD

The disclosure relates to surface cleaning robots, such as robots configured to perform autonomous cleaning tasks.

### BACKGROUND

Wet cleaning of household surfaces has long been done manually using a wet mop or sponge. The mop or sponge is dipped into a container filled with a cleaning fluid to allow the mop or sponge to absorb an amount of the cleaning fluid. The mop or sponge is then moved over the surface to apply a cleaning fluid onto the surface. The cleaning fluid interacts with contaminants on the surface and may dissolve or otherwise emulsify contaminants into the cleaning fluid. The cleaning fluid is therefore transformed into a waste liquid that includes the cleaning fluid and contaminants held in suspension within the cleaning fluid. Thereafter, the sponge or mop is used to absorb the waste liquid from the surface. While clean water is somewhat effective for use as a cleaning fluid applied to household surfaces, cleaning is typically done with a cleaning fluid that is a mixture of clean water and soap or detergent that reacts with contaminants to emulsify the contaminants into the water.

The sponge or mop may be used as a scrubbing element for scrubbing the floor surface, and especially in areas where contaminants are particularly difficult to remove from the household surface. The scrubbing action serves to agitate the cleaning fluid for mixing with contaminants as well as to apply a friction force for loosening contaminants from the floor surface. Agitation enhances the dissolving and emulsifying action of the cleaning fluid and the friction force helps to break bonds between the surface and contaminants.

After cleaning an area of the floor surface, the waste liquid is rinsed from the mop or sponge. This is typically done by dipping the mop or sponge back into the container filled with cleaning fluid. The rinsing step contaminates the cleaning fluid with waste liquid and the cleaning fluid becomes more contaminated each time the mop or sponge is rinsed. As a result, the effectiveness of the cleaning fluid deteriorates as more of the floor surface area is cleaned.

Some manual floor cleaning devices have a handle with a cleaning fluid supply container supported on the handle and a scrubbing sponge at one end of the handle. These devices include a cleaning fluid dispensing nozzle supported on the handle for spraying cleaning fluid onto the floor. These devices also include a mechanical device for wringing waste liquid out of the scrubbing sponge and into a waste container.

Manual methods of cleaning floors can be labor intensive and time consuming. Thus, in many large buildings, such as hospitals, large retail stores, cafeterias, and the like, floors are wet cleaned on a daily or nightly basis. Industrial floor cleaning “robots” capable of wet cleaning floors have been developed. To implement wet cleaning techniques required in large industrial areas, these robots are typically large, costly, and complex. These robots have a drive assembly that provides a motive force to autonomously move the wet cleaning device along a cleaning path. However, because these industrial-sized wet cleaning devices weigh hundreds of pounds, these devices are usually attended by an operator. For example, an operator can turn off the device and, thus, avoid significant damage that can arise in the event of a sensor failure or an unanticipated control variable. As another example, an operator can assist in moving the wet cleaning device to physically escape or navigate among confined areas or obstacles.

### SUMMARY

One aspect of the disclosure provides a mobile robot that includes a body, a drive system movably supporting the body above a cleaning surface, and a cleaning system arranged to clean the cleaning surface. The robot further includes a controller in communication with at least one of the drive system and the cleaning system and a super-hydrophobic coating applied to at least one of the drive system, the cleaning system, and the controller.

Implementations of the disclosure may include one or more of the following features. In some implementations, a water contact angle of the super-hydrophobic coating is greater than or equal to 150 degrees. The super-hydrophobic coating may include nanoparticles between 10 μm-100 nm in size. Moreover, the super-hydrophobic coating may include a polymeric binder, such as one prepared from silicone resin and an acrylic polymer. In some examples, the nanoparticles comprise 20-40% by weight of the composition and the binder comprises 60-80% by weight of the composition.

The robot may include a battery contact treated with the super-hydrophobic coating and in electrical communication with at least one of the controller and the cleaning system. The battery contact blade receives electrical contact with a battery.

The drive system may include right and left drive wheel modules. Each drive wheel module has a drive wheel coupled to a drive motor. At least one of the drive wheel and the drive motor receives the super-hydrophobic coating.

In some implementations, the cleaning system includes a cleaning head (e.g., at least one of a driven brush, a smearing element, and a compliant blade extending across at least a portion of a width of the mobile robot) engaging the cleaning surface. The cleaning head can be treated with the super-hydrophobic coating. In some examples, the cleaning system includes a vacuum assembly, at least a portion of which receives the super-hydrophobic coating, and a squeegee treated with the super-hydrophobic coating. The squeegee extends across a cleaning width of the mobile robot and is arranged for movable engagement with the cleaning surface for collecting and directing liquid on the cleaning surface toward suction apertures defined by the squeegee and in fluid communication with the vacuum assembly.

The cleaning system may include a liquid applicator configured to spray a liquid onto the cleaning surface, a supply volume in fluid communication with the liquid applicator, a liquid collector disposed rearward of the liquid applicator with respect to a forward drive direction, and a waste volume in fluid communication with the liquid collector. At least one of the liquid applicator, the supply volume, the liquid collector, and the waste volume may receive the super-hydrophobic coating. Moreover, internal surfaces of the supply and waste volumes may receive the super-hydrophobic coating as well. In some examples, the liquid applicator includes at least one nozzle arranged for spraying liquid onto the cleaning surface and a pump in fluid communication with the at least one nozzle. At least one of the at least one nozzle and the pump receives the super-hydrophobic coating.

In some implementations, the liquid collector includes a vacuum assembly, at least a portion of which receives the super-hydrophobic coating, and a squeegee treated with the super-hydrophobic coating. The squeegee extends across a cleaning width of the mobile robot and is arranged for movable engagement with the cleaning surface for collecting and directing liquid on the cleaning surface toward suction apertures defined by the squeegee and in fluid communication with the vacuum assembly. The internal surfaces of passageways of the vacuum assembly may receive the super-hydrophobic coating. Moreover, external surfaces of the mobile robot may receive the super-hydrophobic coating.

A sensor system having at least one sensor may communicate a corresponding electric signal to the controller. At least a portion of the sensor system can be treated with the super-hydrophobic coating. The at least one sensor may provide an electric signal corresponding to at least one of an obstacle detection, a low battery power detection, a drive wheel drop event, a cliff detection, a dirty floor detection, an empty supply fluid container detection, a full waste container detection, a drive wheel velocity, a travel distance, a cleaning system error, a cleaning surface type, a stasis detection, and a temperature. In some examples, the robot includes a user interface in communication with the controller and coated with the super-hydrophobic coating.

Another aspect of the disclosure provides a mobile robot including a body, a drive system movably supporting the body above a cleaning surface, and a cleaning system arranged to clean the cleaning surface. The cleaning system includes a vacuum assembly having a collection region engaging the cleaning surface and a suction region in fluid communication with the collection region. The suction region suctions waste from the cleaning surface through the collection region. The cleaning system also includes a collection volume in fluid communication with the vacuum assembly for collecting waste removed by the vacuum assembly, a supply volume carried by the body and configured to hold a cleaning liquid, and a liquid applicator in fluid communication with the supply volume. The liquid applicator dispenses the cleaning liquid onto the cleaning surface (e.g., substantially near a forward end of the body). A wetting element engages the cleaning surface to distribute the cleaning liquid along at least a portion of the cleaning surface when the robot is driven in a forward direction. The robot includes a controller in communication with at least one of the drive system and the cleaning system, and a super-hydrophobic coating applied to at least one of the drive system, the cleaning system, and the controller.

In some implementations, a water contact angle of the super-hydrophobic coating is greater than or equal to 150 degrees. The super-hydrophobic coating may include nanoparticles between 10 μm-100 nm in size. Moreover, the super-hydrophobic coating may include a polymeric binder, such as one prepared from silicone resin and an acrylic polymer. In some examples, the nanoparticles comprise 20-40% by weight of the composition and the binder comprises 60-80% by weight of the composition.

The robot may include a battery contact treated with the super-hydrophobic coating and in electrical communication with at least one of the controller and the cleaning system. The battery contact blade receives electrical contact with a battery.

The drive system may include right and left drive wheel modules. Each drive wheel module has a drive wheel coupled to a drive motor. At least one of the drive wheel and the drive motor receives the super-hydrophobic coating.

In some implementations, at least one of the vacuum assembly, the collection volume, the supply volume, the liquid applicator, and the wetting element receive the super-hydrophobic coating. Moreover, any portion of the body (e.g., a bottom surface of the body exposed to the cleaning surfaces), internal surfaces of passageways of the vacuum assembly, and/or internal surfaces of the supply and waste volumes may receive the super-hydrophobic coating.

The collection region of the vacuum assembly may include a squeegee treated with the super-hydrophobic coating. The squeegee extends across a cleaning width of the mobile robot and arranged for movable engagement with the cleaning surface for collecting and directing liquid on the cleaning surface toward suction apertures defined by the squeegee.

In some implementations, the robot includes a sensor system having at least one sensor communicating a corresponding electric signal to the controller. At least a portion of the sensor system being treated with the super-hydrophobic coating. At least one sensor may provide an electric signal corresponding to at least one of an obstacle detection, a low battery power detection, a drive wheel drop event, a cliff detection, a dirty floor detection, an empty supply fluid container detection, a full waste container detection, a drive wheel velocity, a travel distance, a cleaning system error, a cleaning surface type, a stasis detection, and a temperature. The sensor system may include wire leads and/or wiring treated with the super-hydrophobic coating.

In some examples, the robot includes a user interface in communication with the controller. The user interface may receive the super-hydrophobic coating. Moreover, the robot may include a gasket for sealing at least one of the body, the controller, the drive system, and the cleaning system. The gasket may receive the super-hydrophobic coating.

In yet another aspect, a method of making a mobile robot includes applying a super-hydrophobic coating to at least a portion of a controller, mounting the controller on a body, applying the super-hydrophobic coating to at least a portion of a cleaning system, disposing the cleaning system on the body, and arranging a drive system to movably support the body above a cleaning surface.

In some implementations, a water contact angle of the super-hydrophobic coating is greater than or equal to 150 degrees. The super-hydrophobic coating may include nanoparticles between 10 μm-100 nm in size. Moreover, the super-hydrophobic coating may include a polymeric binder, such as one prepared from silicone resin and an acrylic polymer. In some examples, the nanoparticles comprise 20-40% by weight of the composition and the binder comprises 60-80% by weight of the composition.

The method may include disposing a right drive wheel module substantially opposite a left drive module with respect to a forward drive direction. Each drive wheel module includes a drive wheel driven by a drive motor. The method may include applying the super-hydrophobic coating to at least one of the drive wheel and the drive motor of each drive wheel module.

In some examples, the method includes disposing a cleaning element on the body for engagement with the cleaning surface. The cleaning element extends across at least a portion of a width of the mobile robot and receives the super-hydrophobic coating. Moreover, the cleaning element includes at least one of a driven brush, a smearing element, and a compliant blade.

The method may include disposing a vacuum assembly on the body, where at least a portion of the vacuum assembly receives the super-hydrophobic coating. A squeegee treated with the super-hydrophobic coating can be disposed on the body as well. The squeegee extends across a cleaning width of the mobile robot and is arranged for movable engagement with the cleaning surface for collecting and directing liquid on the cleaning surface toward suction apertures defined by the squeegee and in fluid communication with the vacuum assembly.

In some implementations, the method includes disposing a liquid applicator on the body. The liquid applicator is configured to spray a liquid onto the cleaning surface. The method also includes disposing a supply volume in fluid communication with the liquid applicator, disposing a liquid collector rearward of the liquid applicator with respect to a forward drive direction, and disposing a waste volume in fluid communication with the liquid collector. At least one of the liquid applicator, the supply volume, the liquid collector, and the waste volume receives the super-hydrophobic coating. Moreover, at least a portion of the body and/or internal and/or external surfaces of the supply and waste volumes may receive the super-hydrophobic coating. The liquid applicator may include at least one nozzle arranged for spraying liquid onto the cleaning surface and a pump in fluid communication with the at least one nozzle. At least one of the at least one nozzle and the pump may receive the super-hydrophobic coating.

The method may include disposing a sensor system in communication with the controller. The sensor system includes at least one sensor communicating a corresponding electric signal to the controller and at least a portion of the sensor system is treated with the super-hydrophobic coating. At least one sensor provides an electric signal corresponding to at least one of an obstacle detection, a low battery power detection, a drive wheel drop event, a cliff detection, a dirty floor detection, an empty supply fluid container detection, a full waste container detection, a drive wheel velocity, a travel distance, a cleaning system error, a cleaning surface type, a stasis detection, and a temperature.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of a water droplet on a super-hydrophobic coated surface.

FIG. 1B is a schematic view of a surface receiving a super-hydrophobic treatment.

FIG. 2 is a perspective view of an exemplary autonomous surface cleaning robot.

FIG. 3 is a bottom view of the robot shown in FIG. 2.

FIG. 4 is a side view of the robot shown in FIG. 2.

FIG. 5 is a front view of the robot shown in FIG. 2.

FIG. 6 is a rear view of the robot shown in FIG. 2.

FIG. 7 is an exploded view of the robot shown in FIG. 2.

FIG. 8 is a schematic view of an exemplary wet vacuum system for a surface cleaning robot.

FIG. 9 is an exploded view of an exemplary air mover.

FIG. 10 is a bottom perspective view of an exemplary top cover for a surface cleaning robot.

FIG. 11 is a top perspective view of the top cover shown in FIG. 10.

FIG. 12 is a perspective view of an exemplary autonomous surface cleaning robot.

FIG. 13 is a bottom perspective view of an exemplary chassis and bumper assembly for a surface cleaning robot.

FIG. 14 is a top perspective view of the chassis and bumper assembly shown in FIG. 13.

FIGS. 15 and 16 are partial exploded views of the robot shown in FIG. 12.

FIG. 17 provides an exemplary arrangement of operations for making a mobile robot.

Like reference symbols in the various drawings indicate like elements.

### DETAILED DESCRIPTION

An autonomous or semi-autonomous robot can be configured to clean surfaces in various environments. For example, a robot can vacuum carpeted or hard-surfaces and/or wash floors via liquid-assisted washing and/or wiping and/or electrostatic wiping of relatively hard surfaces. An exemplary robot is disclosed in U.S. application Ser. No. 11/359,961 by Ziegler et al. entitled “Autonomous Surface Cleaning Robot For Wet And Dry Cleaning” and U.S. application Ser. No. 12/983,837, filed on Jan. 3, 2011, which are hereby incorporated by reference in their entireties. A robot can clean surfaces in wet and/or submerged environments, such as cleaning a pool floor and/or walls, cleaning a gutter, lawn care, or other wet applications. Robots exposed to wet environments may need some level of water resistance or water proofing to protect certain components (e.g., electrical components) from fluid exposure, which may cause short circuits, corrosion, or other adverse situations.

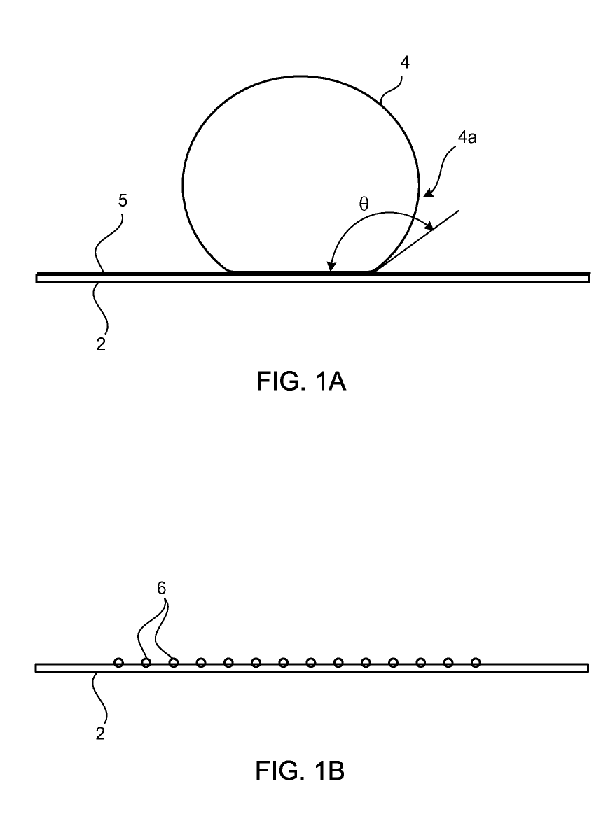

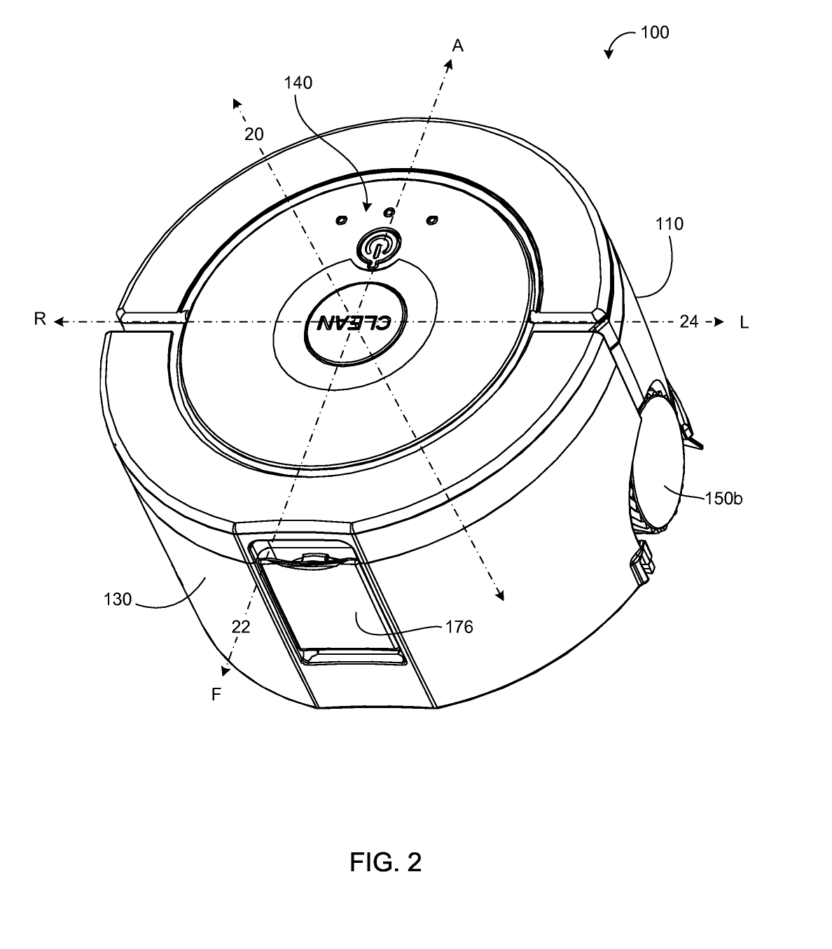

Referring to FIG. 1A, in some implementations, one or more components of a robot are treated with a super-hydrophobic coating 5. The contact angle θ of water (or a liquid) on a surface 2 is the angle of a leading edge 4a of a water droplet 4 on the surface 2 as measured from the center C of the water droplet 4. A surface with a contact angle θ of 180 degrees would mean that water sits on it as a perfect sphere. Hydrophobic surfaces are measured between 90 degrees and 180 degrees. The surface 10 is hydrophobic when it exhibits a contact angle θ greater than 90 degrees and super-hydrophobic when it exhibits a contact angle θ greater than or equal to 150 degrees.

Some coatings provide super-hydrophobic qualities by mimicking the super-hydrophobic behavior of the lotus leaf structure by creating a honeycomb-like polyelectrolyte multilayer surface over-coated with silica nanoparticles. Super-hydrophobicity may be achieved by coating the highly textured multilayer surface with a semi-fluorinated silane. The surface maintains its super-hydrophobic character even after extended immersion in water. Super-hydrophobicity of a surface can be achieved by coating a substrate with various nanoparticles mixed with polymers, electrochemical deposition of gold and silver aggregates followed by chemisorption of a monolayer of n-dodecanothiol, electro-deposition of copper onto the substrate combined with lithography or copper wet etching, a close-packed polystyrene microsphere topography, casting of polymer solutions under humid conditions, replication of the lotus-leaf structure in PDMS by nano-casting, and/or mechanical assembly of monolayers on elastomeric surfaces and a gelation process for polypropylene and tetraethyl orthosilicate mixed with an acrylic polymer.

The super-hydrophobic coating may resist wetting of and corrosion by acids, alkalis, salts, vegetable oils, mineral oils, other oils, and/or other solutions or liquids. Moreover, the super-hydrophobic coated or treated surfaces can become self-cleaning upon exposure to liquids, which subsequently roll off and carry any surface debris therewith. The super-hydrophobic coating or treatment can result in an anti-bacterial surface as well. In some examples, when applied to electrical components, the super-hydrophobic coating or treatment prevents or impedes arcing or static discharges. Exemplary super-hydrophobic coatings include NeverWet by Ross Nanotechnology, LLC, P.O. Box 646, Leola, Pa. 17540; and any super-hydrophobic coatings offered by Oak Ridge National Laboratory, P.O. Box 2008, Oak Ridge, Tenn. 37831.

In some implementations, the super-hydrophobic coating 5 comprises about 20-40% by weight nanoparticles, about 60-80% by weight polymer binder. Optionally the composition can include a solvent in amounts between about 10-30% by weight, and can also optionally include an initiator, present in amounts ranging from about 1-10%. In additional implementations, the super-hydrophobic coating 5 comprises about 20-30% by weight nanoparticles and about 70-80% by weight polymer binder (e.g., 20-25% by weight nanoparticles and 75-80% by weight polymer binder).

The nanoparticles used in compositions of the super-hydrophobic coating 5 may be hydrophobic. Examples of suitable hydrophobic particles include, but are not limited to, silica, alumina, titanium oxide, zirconium oxide, antimony oxide, zinc oxide, tin oxide, indium oxide, cerium oxide, mullite (alumina silicate); other oxides such as iron oxide, nickel oxide, oxides of refractory metals such as molybdenum, niobium, and tungsten, and complex oxides created from co-precipitation or oxidation of complex oxides are also possible.

The nanoparticles used in the compositions of the super-hydrophobic coating 5 can be surface-modified with compounds that make the surface of the particles more hydrophobic. Exemplary compounds include organosilanes, such as polydimethylsiloxane, hexamethyldisilnzane, octyltrimethoxysilane, and dimethyldichlorosilane. Other compounds besides organosilanes that can be used include, for example, any molecule that possesses a hydrophobic chain, e.g. alkyl chain or fluorocarbon chain. These particles can be produced by numerous methods and can be of a variety of shapes including spherical, elongated, asymmetric, fibrous and various combinations of these.

The nanoparticles of the super-hydrophobic coating 5 may be between 5-100 nm in size. Other sizes are possible as well. For example, the nanoparticles can be equal to or above between 5-30 nm in size, and with an upper limit equal to or less than between 40-90 nm in size. An exemplary size range for the nanoparticles is 20-50 nm.

Any suitable polymeric binder can be used, so long as it has the ability to react with the surface to be coated with the super-hydrophobic coating 5. For example, for metal surfaces a good binder could be a polymer that includes an etchant that attaches to the metal surface by etching the surface, such that the metal atoms from the etched surface form bonds with the polymer. Some binders can also form very good mechanical bonds, through the polymerization process that leaves the binder in compression. Examples are thermoplastics and thermosets. These binders do require thermal energy for polymerization. Another set of binders are polyurethanes that polymerize at ambient temperature and tend to produce very strong bonds with the substrates. Additional examples of suitable binders include binders prepared from silicone resins and acrylate polymers.

After the binder has cured, it may be mixed via simple mixing at room temperature with the nanoparticles in the above described ratios. A suitable non-aqueous solvent (e.g., organic solvents, such as toluene and acetone) can be used to bring the mixture to a desired viscosity. The coating is applied to a substrate in the desired thickness and allowed to further cure (e.g., at room temperature or via heating, oven curing, UV curing, and infrared curing, etc.).

The super-hydrophobic coating 5 can be applied to a substrate by any suitable method, for example by spraying, dipping, spin coating, flow coating, meniscus coating, capillary coating, roll coating, and painting. Moreover, the super-hydrophobic coating 5 can be applied to new components on a production floor or applied in the field to existing components. In some examples, the super-hydrophobic coating 5 is applied to a substrate in a single layer or multiple layers, in any desired thickness (e.g., a thickness ranging between 50 nm to several micrometers, or between 5 nm and 50 μm, or between 10-30 μm).

Referring to FIG. 1B, in some implementations, a surface treatment makes the surface 2 super-hydrophobic. For example, powder(s) or particles 6 can be applied to or embedded into the surface 2, which results in the surface exhibiting super-hydrophobicity. The particles used to make super-hydrophobic water repellant powder and super-hydrophobic diatomaceous earth are suitable particles for embedding into the surface 2. U.S. patent application Ser. No. 11/749,852, filed on May 17, 2007 by Brian D'Urso, et al., entitled “Super-Hydrophobic Water Repellant Powder,” which is hereby incorporated by reference in its entirety, describes a plurality of solid particles characterized by particle sizes ranging from at least 100 nm to about 10 μm having a plurality of nanopores that provide flow through porosity. The surface of the particles displays a plurality of spaced apart nanostructured features comprising a contiguous, protrusive material. U.S. patent application Ser. No. 11/777,486, filed on Jul. 13, 2007 by John T. Simpson, et al. entitled “Superhydrophobic Diatomaceous Earth,” which is hereby incorporated by reference in its entirety, describes suitable forms of diatomaceous earth particles. Particles from each of the referenced patent applications can be used alone or in combination with each other or with other materials that will not have a deleterious effect on the hydrophobicity of the final product.

The surface 2 can be first coated with the particles 6 by any conventional means for applying particles to a surface, for example, a slurry, paint, ink, or film comprising the uncoated particles and an appropriate fluid vehicle, such as alcohol and/or water. The mixture can be applied by any conventional coating method, including but not limited to direct application from a container, spraying, painting, rolling, stamping, dip-coating, and the like. In some examples, the surface 2 is dry-coated with the particles 6 (e.g., by direct application from a container, electrostatic spraying, dry-brushing, etc.). Next, the particles 6 are flash bonded to the surface 2. Flash bonding can be defined as a process whereby the surface 2 (and usually also the particles) is rapidly heated to a melting point and/or softening point of the surface 2 so that the particles 6 are adherently bonded to the surface 2. An etchant can be applied to the surface 2 to etch the surface 2 sufficiently to expose the particles 6. Moreover, in some examples, the surface 2 and partially embedded particles 6 can be coated with a hydrophobic coating layer to make the surface 2 super-hydrophobic.

Additional information on hydrophobic and super-hydrophobic coatings can be found in U.S. Patent Application Publication 2010/0314575, having Ser. No. 12/815,535 and filed on Jun. 15, 2010; U.S. Pat. No. 7,150,904; U.S. Pat. No. 7,258,731; PCT Application Serial No. PCT/US05/26625, filed on Jul. 27, 2005; U.S. patent application Ser. No. 11/463,940, filed on Aug. 11, 2006; U.S. patent application Ser. No. 11/873,139, filed on Oct. 16, 2007; U.S. Pat. No. 7,638,182; U.S. Pat. No. 7,697,807; U.S. patent application Ser. No. 11/873,139, filed on Oct. 16, 2007; U.S. Pat. No. 7,697,808; and U.S. Pat. No. 7,754,279, the disclosures of which are hereby incorporated by reference in their entireties.

An autonomous robot movably supported can clean a surface while traversing that surface. The robot can remove wet debris from the surface by agitating the debris and/or wet clean the surface by applying a cleaning liquid to the surface, spreading (e.g., smearing, scrubbing) the cleaning liquid on the surface, and collecting the waste (e.g., substantially all of the cleaning liquid and debris mixed therein) from the surface. Since the wet cleaning robot is exposed to liquids, some components of the robot may need isolation from the liquids. For example, electronic components, such as printed circuit boards, sensors, batteries, motors, electrical leads and connectors, and optionally intermediate components, such as wiring, in contact with the electrical components can receive a hydrophobic or super-hydrophobic coating 5 or treatment. Moreover, non-electrical components in contact with fluids, such as fluid tanks (rigid or flexible tanks), vacuum assemblies, cleaning heads, cleaning elements, external surfaces, wheels, gaskets, etc. can receive the hydrophobic or super-hydrophobic coating 5 or treatment, for example, to reduce/eliminate wetting, fluid retention, corrosion, and/or buildup of dirty water sludge and any resulting bacteria or foul odors.

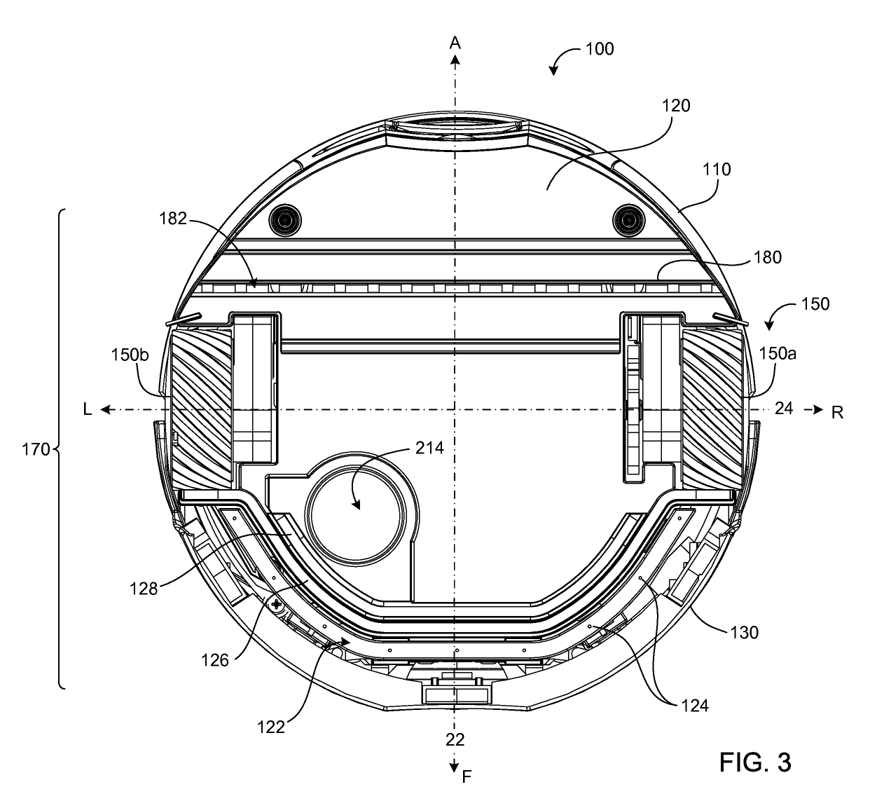

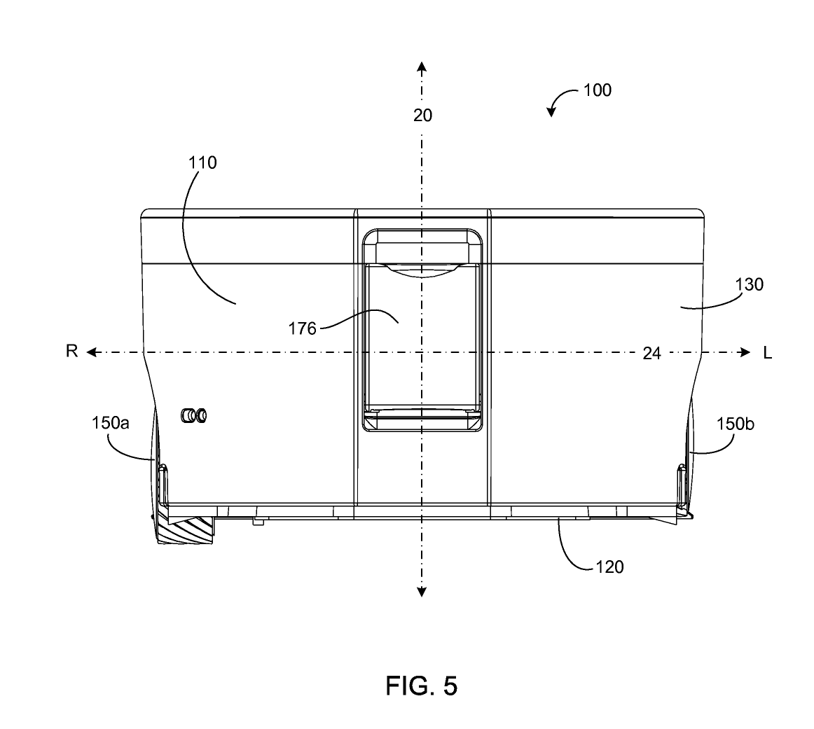

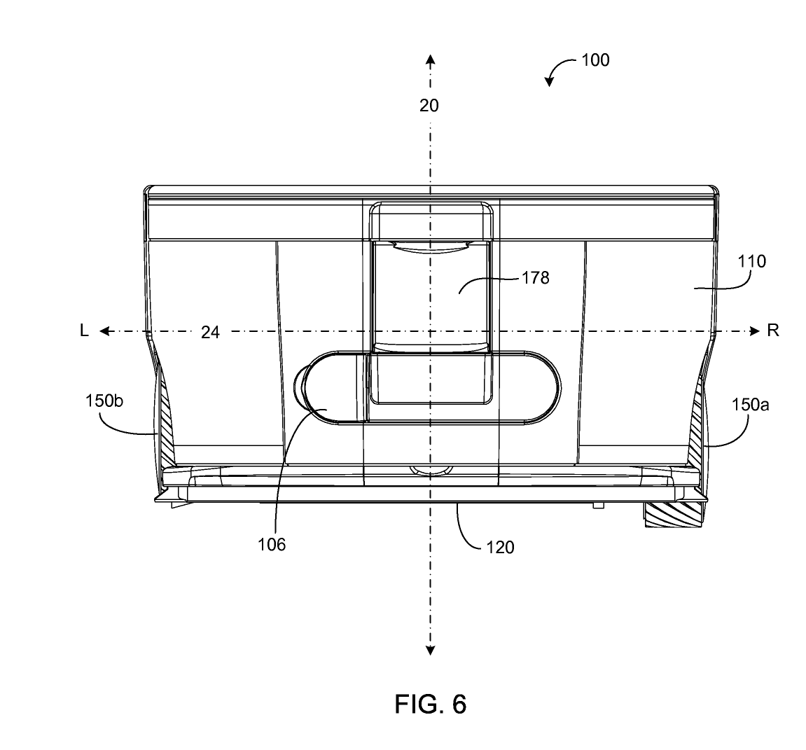

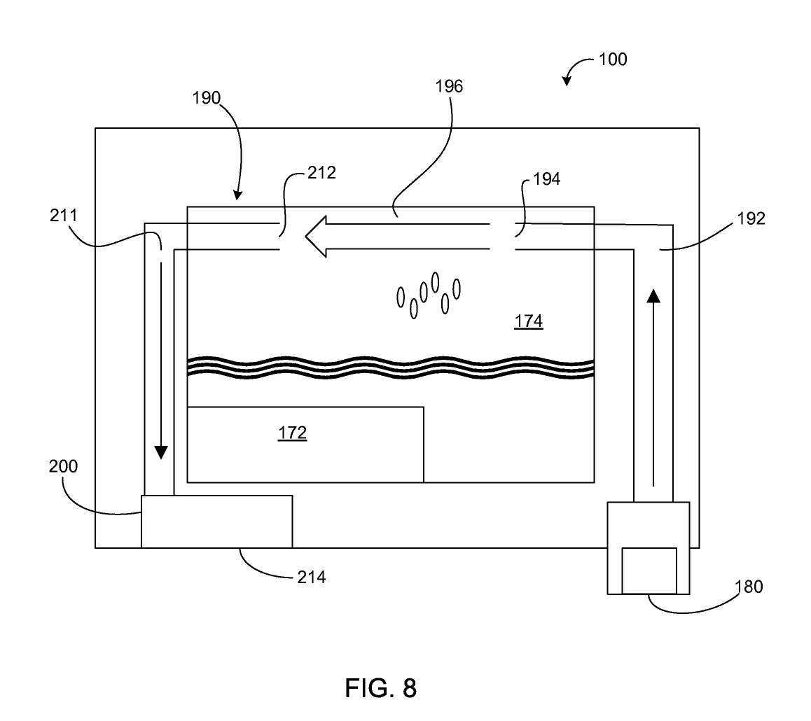

Referring to FIGS. 2-7, a robot 100 includes a chassis 110 carrying a base plate 120, a bumper 130, a user interface 140, and a drive system 150 supporting the chassis 110 and having right and left driven wheel modules 150a, 150b. The wheel modules 150a, 150b are substantially opposed along a transverse axis 24 defined by the chassis 110. The wheel modules 150a, 150b include respective drive motors 152a, 152b driving respective wheels 154a, 154b (see FIG. 7). The drive motors 152a, 152b may releasably connect to the chassis 110 (e.g., via fasteners or tool-less connections) on either side of the liquid volume 171 with the drive motors 152a, 152b optionally positioned substantially over the respective wheels 154a, 154b.

The wheel modules 150a, 150b can be releasably attached to the chassis 110 and forced into engagement with a cleaning surface 10 by respective springs. A super-hydrophobic coating or treatment 5 may be applied to all or portions of the wheel modules 150a, 150b. For example, the drive motors 152a, 152b, wiring, and/or a housing 156a, 156b encapsulating or housing each wheel module 150a, 150b can be treated with a hydrophobic or super-hydrophobic coating 5, while leaving wheel module electrical contracts exposed or covered. The wheel modules 150a, 150b can be substantially sealed from contact with water using one or more the following: a super-hydrophobic coating or treatment 5, epoxy, ultrasonic welding, potting welds, welded interfaces, plugs, and membranes. Moreover, the wheels 154a, 154b can receive the super-hydrophobic coating or treatment 5 to improve wet floor traction. As the treated wheels 154a, 154b roll across the cleaning surface 10, they repel water and liquids, providing relatively greater wheel-to-surface contact. Moreover, the treated wheels 154a, 154b resist wetting and the accumulation of debris, which may reduce traction.

A bottom portion of chassis 110 carries the base plate 120, which at least partially supports a front portion of the chassis 110 above the cleaning surface 10. As the wheel modules 150a, 150b propel the robot 100 across the cleaning surface 10 during a cleaning routine, the base plate 120 may make slidable contact with the cleaning surface 10 and wet-vacuums the surface 10 by delivering cleaning liquid to, spreading the cleaning liquid on, and collecting waste from the cleaning surface 10. The super-hydrophobic coating or treatment 5 may be applied to the base plate 120 to reduce wetting and repel fluid and debris collection thereon. As a result, the robot 100 may traverse a relatively dirty portion of the cleaning surface 10, clean that surface portion without accumulating debris on the base plate 120 or other treated robot portions, and then continue driving over other adjacent cleaning surface portions without carrying any debris onto those cleaning surface portions.

The robot 100 can move across the cleaning surface 10 through various combinations of movements relative to three mutually perpendicular axes defined by the chassis 110: a central vertical axis 20, a fore-aft axis 22 and a transverse axis 24. A forward drive direction along the fore-aft axis 22 is designated F (sometimes referred to hereinafter as “forward”), and an aft drive direction along the fore-aft axis 22 is designated A (sometimes referred to hereinafter as “rearward”). The transverse axis extends between a right side, designated R, and a left side, designated L, of the robot 100 substantially along an axis defined by center points of the wheel modules 150a, 150b.

A forward portion of the chassis 110 carries the bumper 130, which detects (e.g., via one or more sensors, such as a contact sensor 132) one or more events in a drive path of the robot 100, for example, as the wheel modules 150a, 150b propel the robot 100 across the cleaning surface 10 during a cleaning routine. The robot 100 may respond to events (e.g., obstacles, cliffs, walls) detected by the bumper 130 by controlling the wheel modules 150a, 150b to maneuver the robot 100 in response to the event (e.g., away from an obstacle). While some sensors are described herein as being arranged on the bumper, these sensors can additionally or alternatively be arranged at any of various different positions on the robot 100. All or portions of these sensors may receive the super-hydrophobic coating or treatment 5, so as to prevent corrosion, electrical shorts, or other water damage.

A user interface 140 disposed on a top portion of the chassis 110 receives one or more user commands and/or displays a status of the robot 100. The user interface 140 is in communication with a controller 160 carried by the robot 100 such that one or more commands received by the user interface 140 can initiate execution of a cleaning routine by the robot 100. The super-hydrophobic coating or treatment 5 can be applied to the user interface 140, for example, to prevent water or other wet debris on a user's hands from contacting electrical components of the user interface 140 or seeping inside and contacting internal electrical components.

The controller 160 directs motion of the wheel modules 150a, 150b. The controller 160 can control the rotational speed and direction of each wheel module 150a, 150b independently such that the controller 160 can maneuver the robot 100 in any direction across the cleaning surface 10. For example, the controller 160 can maneuver the robot 100 in the forward, reverse, right, and left directions. For example, as the robot 100 moves substantially along the fore-aft axis 22, the robot 100 can make repeated alternating right and left turns such that the robot 100 rotates back and forth around the center vertical axis 20 (hereinafter referred to as a wiggle motion). The wiggle motion can allow the robot 100 to operate as a scrubber during cleaning operation. Moreover, the wiggle motion can be used by the controller 160 to detect robot stasis. Additionally or alternatively, the controller 160 can maneuver the robot 100 to rotate substantially in place such that the robot 100 can maneuver out of a corner or away from an obstacle, for example. The controller 160 may direct the robot 100 over a substantially random (e.g., pseudo-random) path while traversing the cleaning surface 10. The controller 160 can be responsive to one or more sensors (e.g., bump, proximity, wall, stasis, and cliff sensors) disposed about the robot 100. The controller 160 can redirect the wheel modules 150a, 150b in response to signals received from the sensors, causing the robot 100 to avoid obstacles and clutter while treating the cleaning surface 10. If the robot 100 becomes stuck or entangled during use, the controller 160 may direct the wheel modules 150a, 150b through a series of escape behaviors so that the robot 100 can escape and resume normal cleaning operations. All or portions of the controller 160 can receive the super-hydrophobic coating or treatment 5 for sealing against fluid exposure. The super-hydrophobic coating 5 can protect against static discharge, electric arcing, and other potentially damaging events.

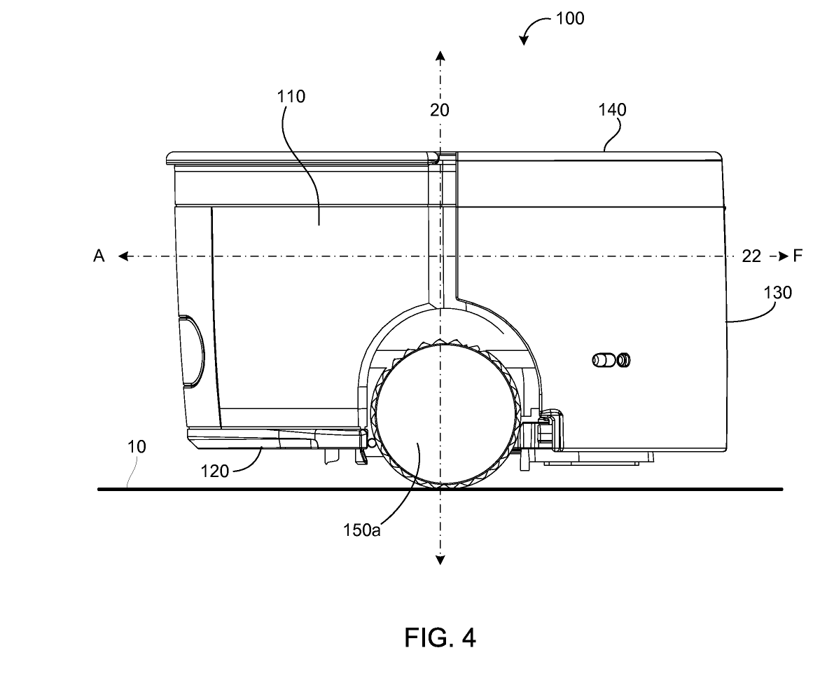

Referring to FIGS. 3 and 7, the robot 100 includes a wet cleaning system 170 having a liquid volume 171 disposed on the chassis 110. The liquid volume 171 includes a supply volume 172 and a waste volume 174, for storing clean fluid and waste fluid, respectively. The super-hydrophobic coating or treatment 5 can be applied to an interior and/or exterior of the liquid volume 171 (e.g., including the supply and/or waste volumes 172, 174). Application of the hydrophobic or super-hydrophobic coating to the exterior of the liquid volume 171 can prevent liquid from escaping and contacting other components of the robot 100. Application of the super-hydrophobic coating or treatment to the interior surfaces of the supply and/or waste volumes 172, 174 can also prevent escapement of fluid from the liquid volume 171 as well as prevent or impede corrosion or particulate build-ups on the interior surfaces of the supply and/or waste volumes 172, 174. Moreover, the super-hydrophobic coating 5 can provide an anti-bacterial quality to the liquid volume 171, allowing clean liquid in the supply volume 172 to remain clean and allowing substantially complete removal (e.g., by dumping) of waste liquid in the waste volume 174, thus impeding bacterial formations, build-ups, or the like. The supply and waste collection volumes may be of the same or difference sizes. For example, the waste collection volume 174 may be larger than the supply volume 172 (e.g., by greater than 20%) to accommodate collected debris. In use, a user opens a fill door 176 disposed along the bumper 130 and pours cleaning fluid into a supply port 173 in fluid communication with the supply volume 172. The supply port 173 may be flexibly connected to the bumper 130. After adding cleaning fluid to the robot 100, the user then closes the fill door 176 which forms a water-tight seal with the bumper 130 or, in some implementations, with a port extending through the bumper 130. The user then sets the robot 100 on the surface 10 to be cleaned and initiates cleaning by entering one or more commands on the user interface 140. The supply port 173 and/or the bumper 130 can be treated with a hydrophobic or super-hydrophobic coating to prevent wetting about the bumper 130.

In some implementations, the supply volume 172 and the waste collection volume 174 are configured to maintain a substantially constant center of gravity along the transverse axis 24 while at least 25 percent of the total volume of the robot 100 shifts from cleaning liquid in the supply volume 172 to waste in the collection volume 174 as cleaning liquid is dispensed from the supply volume 172 onto the cleaning surface 10 and then collected as waste with debris in the collection volume 174.

In some implementations, all or a portion of the supply volume 172 is a flexible bladder within the waste collection volume 174 and surrounded by the waste collection volume 174 such that the bladder compresses as cleaning liquid exits the bladder and waste filling the waste collection volume 174 takes place of the cleaning liquid that has exited the bladder. Such a system can be a self-regulating system which can keep the center of gravity of the robot 100 substantially in place (e.g., over the transverse axis 24). For example, at the start of a cleaning routine, the bladder can be full such that the bladder is expanded to substantially fill the waste collection volume 174. As cleaning liquid is dispensed from the robot 100, the volume of the bladder decreases such that waste entering the waste collection volume 174 replaces the displaced cleaning fluid that has exited the flexible bladder. Toward the end of the cleaning routine, the flexible bladder is substantially collapsed within the waste collection volume 174 and the waste collection volume 174 is substantially full of waste.

While the supply volume 172 has been described as a flexible bladder substantially surrounded by the waste collection volume 174, other configurations are possible. For example, the supply volume 172 and the waste collection volume 174 can be compartments that are stacked or partially stacked on top of one another with their compartment-full center of gravity within 100 cm of one another. Additionally or alternatively, the supply volume 172 and the waste collection volume 174 can be concentric (concentric such that one is inside the other in the lateral direction); or can be interleaved (e.g., interleaved L shapes or fingers in the lateral direction).

Referring to again to FIG. 3, during wet vacuuming, the robot 100 dispenses cleaning liquid onto the surface 10, in some implementations, through an applicator mounted directly to the chassis 110 (e.g., to be used as an attachment point for the bumper and/or to conceal wires). Additionally or alternatively, the cleaning liquid can be dispensed to the cleaning surface 10 through an applicator mounted to the base plate 120. For example, cleaning liquid can be dispensed through an applicator trough 122 disposed on the base plate 120, along a substantially forward portion of the robot 100. The trough 122 defines injection orifices 124 configured along the length of the trough 122 to produce a spray pattern of cleaning fluid. A pump 125 (FIG. 7) upstream of the trough 122 forces cleaning liquid through the injection orifices 124 to deliver cleaning liquid to the cleaning surface 10. All or a portion of the pump 125 can receive the super-hydrophobic coating or treatment 5 (e.g., to prevent fluid escapement into the interior of the robot 100). In some implementations, the injection orifices 124 are spaced substantially equidistantly long the trough 122 to produce a substantially uniform spray pattern of cleaning liquid onto the cleaning surface 10. The injection orifices 124 may be configured to allow the cleaning liquid to drip from the injection orifices 124 onto the cleaning surface 10. The injection orifices 124 may receive the super-hydrophobic coating or treatment 5 to prevent corrosion and build-ups on thereon, which could distort the spray direction and/or spray pattern.

A first wetting element 126 carried by the base plate 120 substantially rearward of the trough 122 slidably contacts the cleaning surface 10 to support a forward portion of the robot 100 above the cleaning surface 10. Ends of the first wetting element 126 extend in the transverse direction substantially the entire width (e.g., diameter) of the robot 100. The first wetting element 126 may comprise a flexible compliant blade having a first edge configured for slidable contact with the cleaning surface 10 and a second edge configured for attachment to the chassis 110. The wetting element 126 defines a substantially arcuate shape that extends substantially parallel to the forward perimeter of the robot 100. As the robot 100 moves in a substantially forward direction, the sliding contact between the first wetting element 126 and the cleaning surface 10 spreads the cleaning liquid on the cleaning surface 10. The substantially arcuate shape of the first wetting element 126 can allow one or more components (e.g., a printed circuit board (PCB)) to be positioned within the boundary defined by the first wetting element 126. In some implementations, a second wetting element 128 is carried on the base plate 120, substantially rearward of the first wetting element 126 to further spread and/or agitate the cleaning liquid on the cleaning surface 10. The first and/or second wetting elements 126, 128 may receive the super-hydrophobic coating or treatment 5 to limit wetting, improve fluid dispersion, and impede corrosion and build-ups thereon.

As the robot continues to move forward, the wheel modules 150a, 150b pass through and spread the cleaning liquid on the cleaning surface 10. A combination of weight distribution (e.g., drag) of the robot 100, material selection for the tires of the wheel modules 150a, 150b, and a biased-to-drop suspension system improve the traction of wheel modules 150a, 150b through the cleaning liquid such that wheel modules 150a, 150b can pass over the cleaning liquid without substantial slipping.

A squeegee 180 disposed on the base plate 120 extends from the base plate 120 to movably contact the cleaning surface 10. The squeegee 180 is positioned substantially rearward of the wheel modules 150a, 150b. As compared to a robot including a squeegee in a more forward position, such rearward positioning of the squeegee 180 can increase the dwell time of the cleaning liquid on the cleaning surface 10 and, thus, increase the effectiveness of the cleaning operation. Additionally or alternatively, such rearward positioning of the squeegee 180 can reduce rearward tipping of the robot 100 in response to thrust created by the wheel modules 150a, 150b propelling the robot 100 in a forward direction. The movable contact between the squeegee 180 and cleaning surface 10 acts to lift waste (e.g., a mixture of cleaning liquid and debris) from the cleaning surface 10 as the robot 100 is propelled in the forward direction. The squeegee 180 may receive the super-hydrophobic coating or treatment 5 for directing or pooling the waste substantially near suction apertures 182 defined by the squeegee 180. A vacuum assembly 190 carried by the robot 100 suctions the waste from the cleaning surface and into the robot 100, leaving behind a wet vacuumed cleaning surface 10.

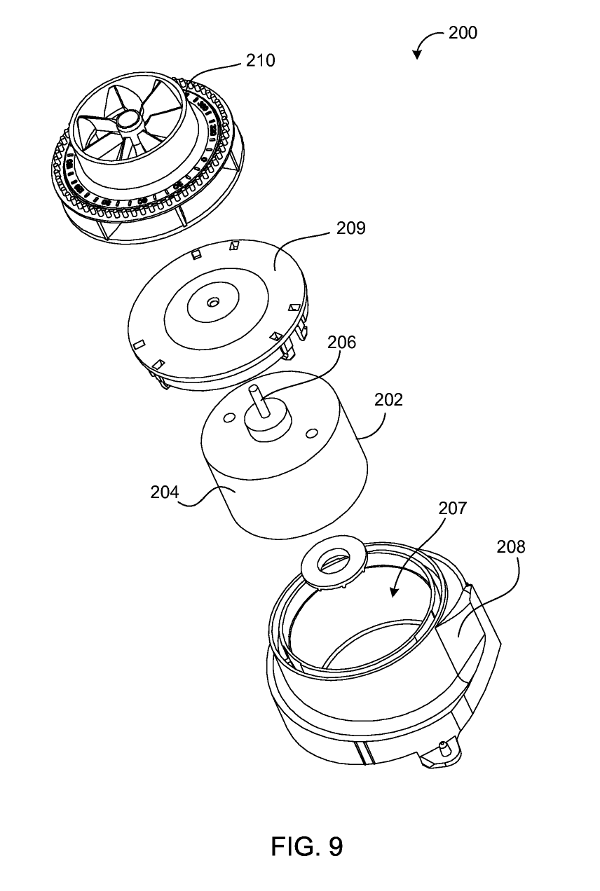

Referring to FIGS. 8-10, the vacuum assembly 190 includes a fan 200 in fluid communication with the waste collection volume 174 and the squeegee 180 in contact with the cleaning surface 10. In use, the fan 200 creates a low pressure region along the fluid communication path including the waste collection volume 174 and the squeegee 180. The fan 200 creates a pressure differential across the squeegee 180, resulting in suction of waste from the cleaning surface 10 and through the squeegee 180. The suction force created by the fan 200 can further suction the waste through one or more waste intake conduits 192 (e.g., conduits disposed on either end of the squeegee 180) toward a top portion of the waste collection volume 174.

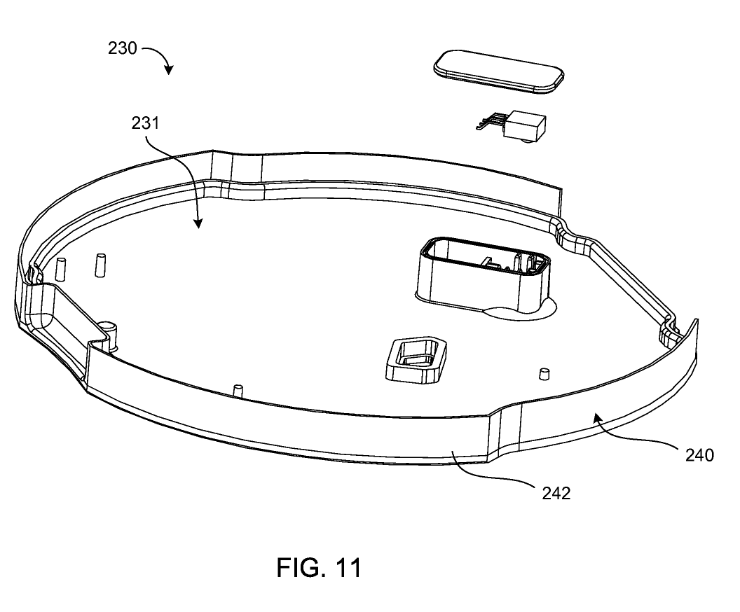

In the examples shown, the top portion of the waste collection volume 174 defines a plenum 196 between exit apertures 194 of waste inlet conduits 192 and inlet aperture 212 of a fan intake conduit 211. While the fan 200 is in operation, the flow of air and waste through plenum 196 generally moves from exit apertures 194 toward the inlet aperture 212. In some implementations, the plenum 196 has a flow area greater than the combined flow area of the one or more waste intake conduits 192 such that, upon expanding in the top portion of the waste collection volume 174, the velocity of the moving waste decreases. At this lower velocity, heavier portions of the moving waste (e.g. water and debris) will tend to fall into the waste collection volume 174 under the force of gravity while lighter portions (e.g., air) of the moving waste will continue to move toward one or more fan inlet conduits 211. The flow of air continues through the fan inlet conduit 211, through the fan 200, and exits the robot 100 through a fan exit aperture 214 (FIG. 3). A top cover 230 may form a top portion of the liquid volume 171 and/or define the plenum 196 and conduits 211, 212, 192, 194, as shown in FIG. 10. Moreover, the top cover 230, the plenum, any of the conduits 211, 212, 192, 194, and/or any filters can receive the super-hydrophobic coating or treatment 5 to repel fluid and impede fluid or debris collection thereon. The super-hydrophobic coating 5 may allow relatively more efficient fluid pickup through reduced wetting of walls of the top cover 230, the plenum, and/or any of the conduits 211, 212, 192, 194. The walls range from vertical (pulling fluid up) to horizontal (conveying fluid across). Moreover, any component of the vacuum assembly 190 can receive the super-hydrophobic coating or treatment 5 to allow more efficient fluid pickup and prevent wet debris build-ups.

The vacuum module 190 can include a passive anti-spill system and/or an active anti-spill system that substantially prevents waste from exiting waste collection volume 174 when the robot 100 is not in use (e.g., when a user lifts the robot 100 from the surface). In some implementations of a passive anti-spill system, the one or more waste intake conduits 192 and the fan intake conduit 210 can be oriented relative to one another such each exit aperture 194 of the one or more waste intake conduits 192 is substantially perpendicular to the fan inlet aperture 212. Such a perpendicular orientation can reduce the likelihood that waste will traverse the plenum 196 and reach the fan 200 at the end of the fan intake conduit 210. Any anti-spill system can include seals throughout the vacuum module 190 to reduce the likelihood of spilling therefrom. Examples of seals that can be used in anti-spill systems include epoxy, ultrasonic welding, plugs, gaskets, and polymeric membranes. Moreover, interior and/or exterior surfaces of the vacuum module 190 can receive the super-hydrophobic coating or treatment 5.

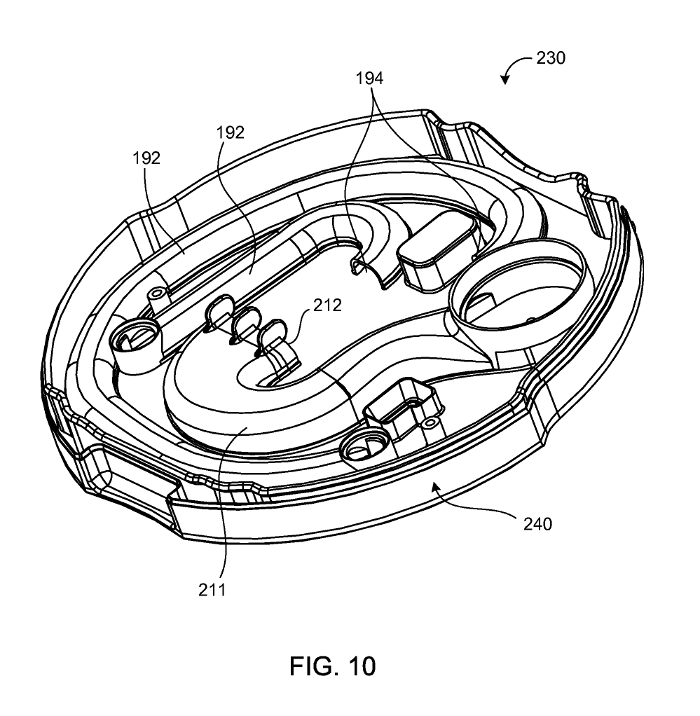

Referring to FIG. 9, the fan 200 includes a rotary fan motor 202, having a fixed housing 204 and a rotating shaft 206 extending therefrom. The fixed motor housing 204 is disposed in a center portion 207 of a fan scroll 208. A fan seal 209 is configured to engage the fan scroll 208 to substantially cover the fan motor 202 disposed substantially within the center portion 207 of the fan scroll 208. Together, the fan seal 209 and the fan scroll 208 form a protective housing that can protect the fan motor 202 from moisture and debris. In some implementations, the super-hydrophobic coating or treatment 5 is applied to all or a portion of the fan 200, such as the motor housing 204 and a fan impeller 210, which may eliminate the need for the seal 209 and/or provided additional sealing to protect the fan motor 202 from exposure to liquid. The rotating shaft 206 of the fan motor 202 projects outward through the fan seal 209 to connect to the impeller 210. In use, the fan motor 202 rotates the rotating shaft 206 to turn the impeller 210 and, thus, move air.

The fan impeller 210 includes a plurality of blade elements arranged about a central rotation axis thereof and is configured to draw air axially inward along its rotation axis and expel the air radially outward when the impeller 210 is rotated. Rotation of the impeller 210 creates a negative air pressure zone (e.g., a vacuum) on its input side and a positive air pressure zone at its output side. The fan motor 202 is configured to rotate the impeller 210 at a substantially constant rate of rotational velocity, e.g., 14,000 RPM, which generates a higher air flow rate than conventional fans for vacuum cleaners or wet vacuums. Rates as low as about 1,000 RPM and as high as about 25,000 RPM are contemplated, depending on the configuration of the fan.

Scroll 208 can fold back in on itself to allow a 30 percent larger impeller, without any loss in scroll volume while maintaining the same package size. The inducer is the portion of the fan blade dedicated to inlet flow only. A “moat” (i.e., a channel or wall) can be positioned in front of the impeller to reduce the likelihood of water entering the impeller. The impeller 210 used for air handling moves air through the system at considerable velocity, which can lead to water being pulled out of the dirty tank, through the impeller 210, and back to the cleaning surface 10. The moat is configured to prevent or limit this occurrence.

After all of the cleaning fluid has been dispensed from the robot 100 (e.g., form the supply volume 172), the controller 160 stops movement of the robot 100 and provides an alert (e.g., a visual alert or an audible alert) to the user via the user interface 140. The user can then open an empty door 178 to expose a waste port defined by the waste collection volume 174 remove collected waste from the robot 100. Because the fill door 176 and the empty door 178 are disposed along substantially opposite sides of the chassis, the fill door 176 and the empty door 178 can be opened simultaneously to allow waste to drain out of the robot 100 while adding cleaning liquid to the robot 100.

The liquid volume 171 isolates substantially the entire electrical system of the robot 100 from carried fluid. Examples of sealing that can be used to separate electrical components of the robot 100 from the cleaning liquid and/or waste include application of the super-hydrophobic coating or treatment 5, covers, plastic or resin modules, potting, shrink fit, gaskets, or the like. Any and all elements described herein as a circuit board, PCB, detector, or sensor can be sealed using the super-hydrophobic coating or treatment 5 or any of various different methods. Moreover, electrical components and/or components in intermediate contact with electrical components can receive the super-hydrophobic coating or treatment 5 to prevent conveyance of fluid to the electrical components.

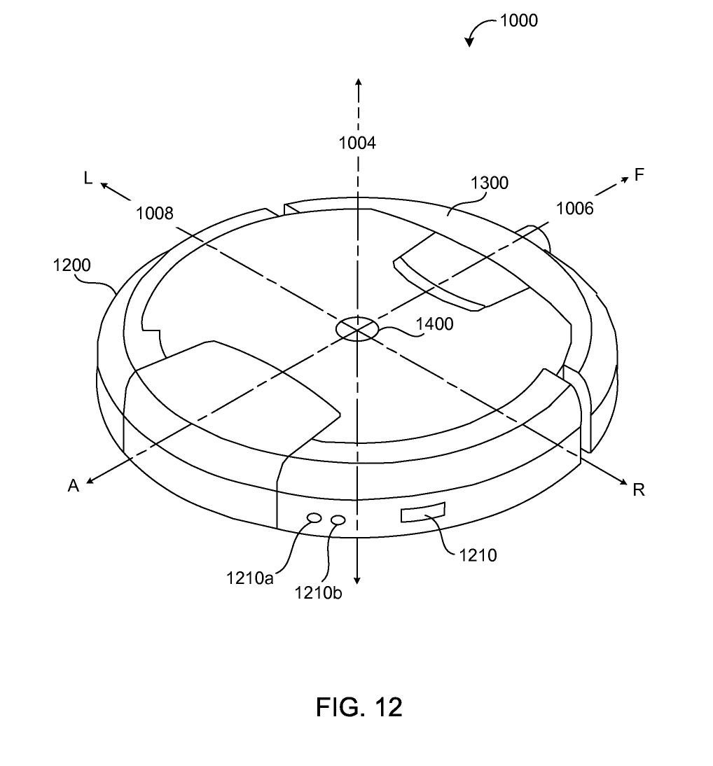

Referring to FIGS. 7, 10 and 11, in some implementations, the top cover 230 includes a signal guide 240 is connected to a top portion of chassis 110 and substantially covers the liquid volume 171 to allow components to be attached along a substantially top portion of the robot 100. A surface 231 of the top cover 230 and/or the signal guide 240 can receive the super-hydrophobic coating or treatment 5 to repel fluid and seal the signal guide 240 from fluid infiltration. An edge of the signal guide 242 is visible from substantially the entire outer circumference of the robot 100 to allow the signal guide 242 to receive a light signal (e.g., an infrared light signal) from substantially any direction. The signal guide 240 receives light from a light source (e.g., a navigation beacon) and internally reflects the light toward a receiver disposed within the signal guide 240. For example, the signal guide 240 can be at least partially formed of a material (e.g., polycarbonate resin thermoplastic) having an index of refraction of about 1.4 or greater to allow substantially total internal reflection within the signal guide 240. Additionally or alternatively, the signal guide 240 can include a first mirror disposed along a top surface of the signal guide 240 and a second mirror disposed along a bottom surface of the signal guide 240 and facing the first mirror. In this configuration, the first and second mirrors can internally reflect light within the signal guide 240.

The signal guide 240 defines a recessed portion 244 that can support at least a portion of the user interface 140. A user interface printed circuit board (PCB) 246 can be arranged in the recessed portion 244 and sealed from liquid. In some examples, a membrane covers the user interface 140. In additional examples, the user interface PCB 246 receives the super-hydrophobic coating or treatment 5, thus sealing the component from fluid infiltration or exposure.

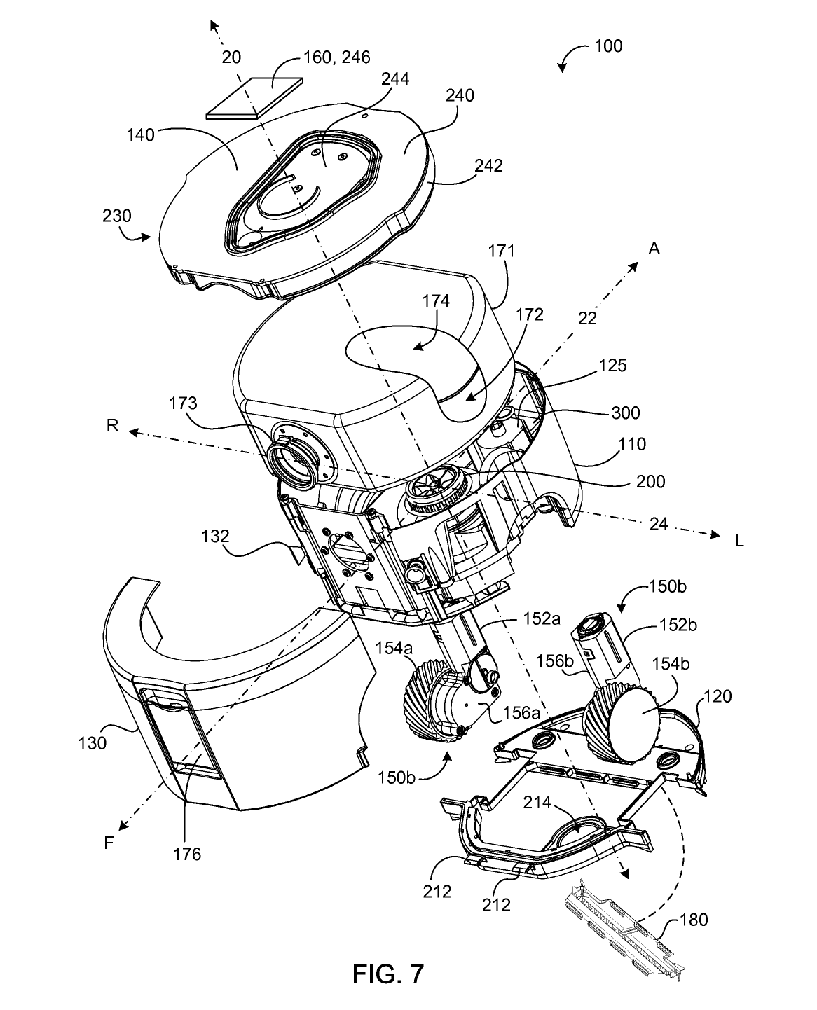

Referring to FIGS. 6 and 7, between uses, the user can recharge a power supply 300 (e.g., battery) carried on-board the robot 100. To charge the power supply 300, the user can open a charge port door 106 (FIG. 6) on a back portion of the chassis 110. With the charge port door 106 open, the user can connect a wall charger to a charge port behind the charge port door 106. The wall charger is configured to plug into a standard household electrical outlet. During the charging process, one or more indicators (e.g., visual indicators, audible indicators) on the user interface 140 can alert the user to the state of charge of the power supply. Once the power supply has been recharged (e.g., as indicated by the user interface 140), the user can disconnect the robot 100 from the wall charger and close the charge port door 106. The charge port door 106 forms a substantially water-tight seal with the chassis 110 such that the charge port remains substantially free of liquid when the charge port door 106 is closed. In some implementations, the power supply is removed from the robot 100 and charged separately from the robot 100. In some implementations, the power supply 300 is removed and replaced with a new power supply. In some implementations, the robot 100 is recharged through inductive coupling between the robot 100 and an inductive transmitter. Such inductive coupling can improve the safety of the robot 100 by reducing the need for physical access to electronic components of the robot 100. In some examples, the power supply 300 and/or charge port door 106 receives the super-hydrophobic coating or treatment 5, so as to repel fluid and prevent or impede fluid contact with those or other electrical components.

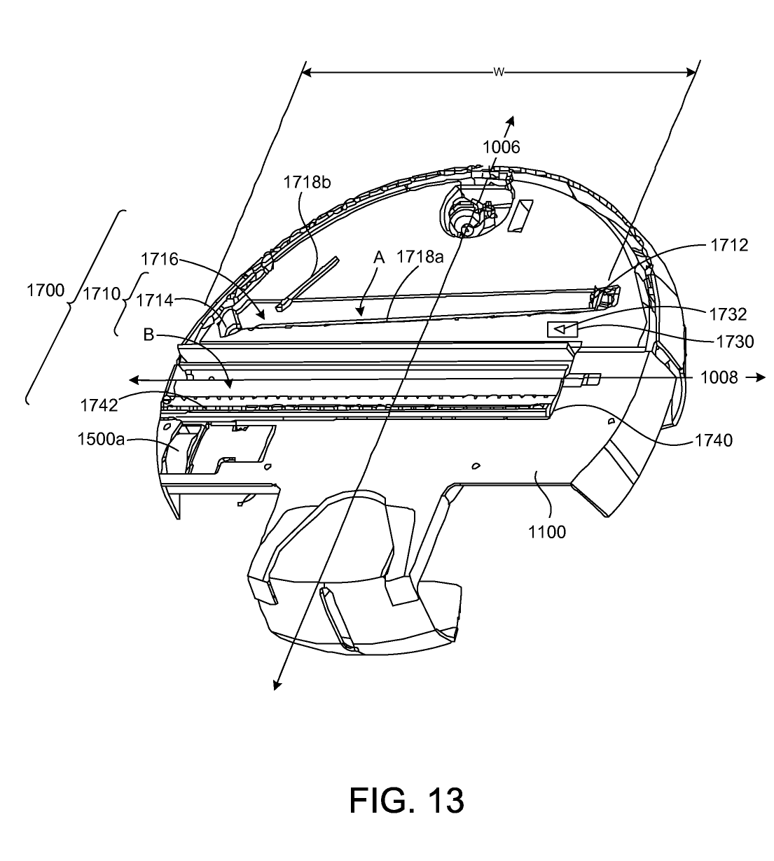

Referring to FIGS. 12-16, in some implementations, a robot 1000 includes a chassis 1100 supporting a body 1200 defining a generally cylindrical volume defined by three mutually perpendicular axes; a central vertical axis 1004, a fore-aft axis 1006, and a transverse axis 1008. The chassis 1100 may support a bumper 1300 and a user interface 1400. A drive system 1500 supports the chassis 1100 for maneuvering across a cleaning surface 10 to be cleaned. The robot 1000 is generally advanced in a forward or fore travel direction, designated F, during cleaning operations. The opposite travel direction, (i.e. opposed by 180°), is designated A for aft. The transverse axis extends between a right side, designated R, and a left side, designated L, of the robot 1000. The drive system 1500 includes right and left wheel modules 1500a, 1500b substantially opposed along the transverse axis 1008. The wheel modules 1500a, 1500b include respective drive motors 1520a, 1520b driving respective wheels 1540a, 1540b. The drive motors 1520a, 1520b may releasably connect to the chassis 1100 (e.g., via fasteners or tool-less connections) with the drive motors 1520a, 1520b optionally positioned substantially adjacent the respective wheels 1540a, 1540b. All or portions of the drive system 1500 can receive the super-hydrophobic coating or treatment 5. For example, wheel module housings 1530a, 1530b and/or the respective drive motors 1520a, 1520b housed therein can receive the super-hydrophobic coating or treatment 5. Moreover, the chassis 1100 may receive the super-hydrophobic coating or treatment 5 to limit wetting and/or wet debris build-ups thereon.

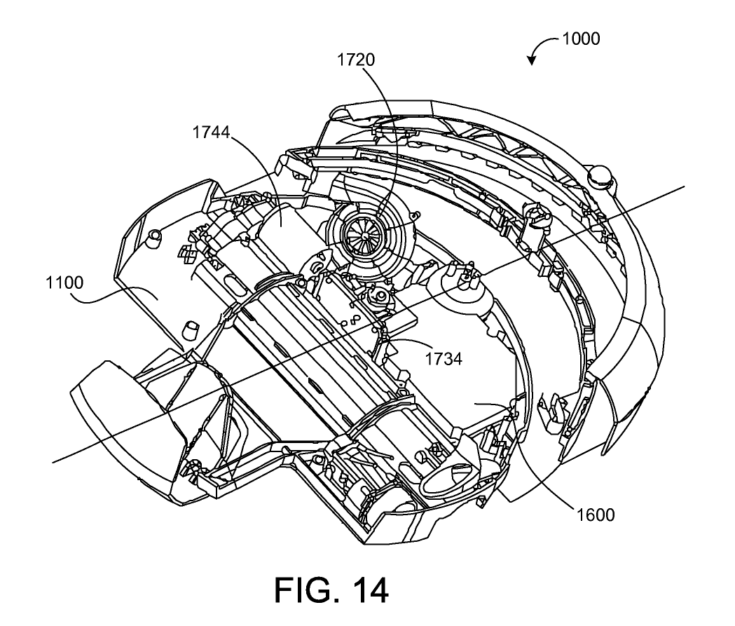

The robot 1000 includes a controller 1600, a cleaning system 1700, and a battery 1900 disposed on the chassis 1100, each of which can receive the super-hydrophobic coating or treatment 5. Referring to FIG. 13, the cleaning system 1700 includes a plurality of cleaning modules supported on a chassis 1100 for cleaning the cleaning surface 10 as the robot is transported over the cleaning surface 10. The cleaning modules extend below the robot chassis 1100 to contact or otherwise operate on the cleaning surface during cleaning operations. Any of the cleaning modules can receive the super-hydrophobic coating or treatment 5, for example, to limit wetting, aid fluid dispersion (if any), and impede fluid collection and waste build-up thereon.

The robot 1000 may be configured so that the cleaning system 1700 has a first cleaning zone A for collecting loose particulates from the cleaning surface 10 and for storing the loose particulates in a receptacle carried by the robot 1000. The robot 1000 may also be configured so that the cleaning system 1700 has a second cleaning zone B that at least applies a cleaning fluid onto the cleaning surface 10. The first and/or second cleaning zones A, B may receive the super-hydrophobic coating or treatment 5 to limit wetting and fluid or debris collection and impede waste build-up thereon. The cleaning fluid may be clean water alone or clean water mixed with other ingredients to enhance cleaning. The application of the cleaning fluid serves to dissolve, emulsify or otherwise react with contaminants on the cleaning surface to separate contaminants therefrom. Contaminants may become suspended or otherwise combined with the cleaning fluid. After the cleaning fluid has been applied onto the cleaning surface 10, it mixes with contaminants and becomes waste material, e.g., a liquid waste material with contaminants suspended or otherwise contained therein.

The underside of the robot 1000, shown in FIG. 13, depicts a first cleaning zone A disposed forward of the second cleaning zone B with respect to the fore-aft axis 1006. Accordingly, the first cleaning zone A precedes the second cleaning zone B over the cleaning surface 10 when the robot 1000 travels in the forward direction F. Any or all portions of the robot underside can receive the super-hydrophobic coating or treatment 5 to repel fluid and/or impede wetting or fluid collection through water surface tension or sticky characteristics of debris from the cleaning surface 10. The first and second cleaning zones A, B are configured with a cleaning width W that is generally oriented parallel or nearly parallel with the transverse axis 1008. The cleaning width W defines the cleaning width W or cleaning footprint of the robot 1000. As the robot 1000 advances over the cleaning surface 10 in the forward direction, the cleaning width W is the width of cleaning surface cleaned by the robot 1000 in a single pass. The cleaning width W may extend across the full transverse width of the robot 1000 to optimize cleaning efficiency; however, in some implementations, the cleaning width W is slightly narrower that the robot transverse width. The robot 100 may traverse the cleaning surface 10 in the forward direction F over a cleaning path with both cleaning zones A, B operating simultaneously.

The first cleaning zone A precedes the second cleaning zone B over the cleaning surface 10 and collects loose particulates from the cleaning surface 10 across the cleaning width W. The second cleaning zone B applies cleaning fluid onto the cleaning surface 10 across the cleaning width W. The second cleaning zone B may also be configured to smear the cleaning fluid applied onto the cleaning surface 10 to smooth the cleaning fluid into a more uniform layer and to mix the cleaning fluid with contaminants on the cleaning surface 10. The second cleaning zone B may also be configured to scrub the cleaning surface 10 across the cleaning width W. The scrubbing action agitates the cleaning fluid to mix it with contaminants. The scrubbing action also applies a shearing force against contaminants to thereby dislodge contaminants from the cleaning surface 10. The second cleaning zone B may also be configured to collect waste liquid from cleaning surface 10 across the cleaning width W.

Referring to FIGS. 13-16, in some implementations, the cleaning system 1700 includes an air moving system 1710 that includes an air jet port 1712 disposed on a left edge of the first cleaning zone A for expelling a continuous jet or stream of pressurized air across the cleaning width W from left to right. An air intake port 1714, disposed opposed to the air jet port 1712 on a right edge of the first cleaning zone A, generates a negative air pressure zone to suction loose particulates and air into the air intake port 1714. The air moving system 1710 deposits the collected particulates into a waste material container 1820 of a tank 1800 carried by the robot 1000. An internal lower surface of the tank 1800 and the internal upper surface of the chassis 1100 can be configured to substantially conform with the shape of the battery 1900. An air mover 1720 (e.g., fan) disposed in pneumatic communication with the air jet port 1712 and the air intake port 1714 provides pressurized air for delivering the air jet and creating the negative air pressure zone, e.g., via an air manifold 1722. The first cleaning zone A is further defined by a nearly rectangular channel 1716 formed between the air jet port 1712 and the air intake port 1714. A first air guide blade 1718a (e.g., made of a compliant material) may be mounted rearward of the channel 1716 to direct debris toward the air intake port 1714 and substantially prevents loose particulates and airflow from escaping the first cleaning zone A in the aft direction. A second air guide blade 1718b (e.g., made of a compliant material) may be mounted in the first cleaning zone A to further guide the air jet toward the negative pressure zone surrounding the air intake port 1714. The second air guide blade 1718b protrudes into the channel 1716 at an acute angle typically between 30-60 degrees with respect to the traverse axis 1008. Any or all portions of the air moving system 1720 can receive the super-hydrophobic coating or treatment 5.

The second cleaning zone B includes a liquid applicator 1730 (also or alternatively, spray head and/or spreader) configured to apply a cleaning fluid onto the cleaning surface 10 (e.g., uniformly across the entire cleaning width W). The liquid applicator 1730 is attached to the chassis 1100 and includes at least one nozzle 1732 in fluid communication with a pump 1734 (e.g., a cam-driven pump) and configured to spray the cleaning fluid onto the cleaning surface 10. The liquid applicator or any portion thereof, such as the nozzle(s) 1732 and pump 1734 can receive the super-hydrophobic coating or treatment 5 to seal that system from fluid escapement, for example, and/or limit wetting and impede wet debris build-ups thereon. The pump 1734 receives fluid from a supply tank 1810 carried by the robot body 1200 (e.g., a portion of the tank 1800). The external surface of the supply tank 1810 can receive the super-hydrophobic coating or treatment 5 to seal the tank 1810. Moreover, the internal surface of the supply tank 1810 can receive the super-hydrophobic coating or treatment 5 to provide an anti-bacterial and/or anti-wetting characteristic, and/or prevent or impede corrosion or accumulation of particulate, debris, sludge or other build-ups inside the tank 1810.

The second cleaning zone B may also include a scrubbing module 1740 (also or alternatively, a powered brush) for performing other cleaning tasks across the cleaning width after the cleaning fluid has been applied onto the cleaning surface 10. The scrubbing module 1740 may include a smearing element disposed across the cleaning width W for smearing the cleaning fluid to distribute it more uniformly on the cleaning surface 10. In the example shown, the scrubbing module 1740 comprises a brush 1742 powered by a brush motor 1744. The brush 1742 and/or brush motor 1744 can receive the super-hydrophobic coating or treatment 5. The coating or treatment on the brush 1742 can prevent or impede fluid retention and debris build-up thereon and may improve fluid dispersion on the cleaning surface 10. The coating or treatment seals the brush motor 1744 from fluid exposure.

The second cleaning zone B may also include a passive or active scrubbing element, scrub brush, wiper, or wipe cloth configured to scrub the cleaning surface across the cleaning width W, which may also receive the super-hydrophobic coating or treatment 5. The second cleaning zone B may also include a second collecting apparatus (also or alternatively, wet vacuum, directed at either a wet surface or a wet brush) configured to collect waste materials up from the cleaning surface 10 across the cleaning width W, and the second collecting apparatus is especially configured for collecting liquid waste materials. The second collecting apparatus may receive the super-hydrophobic coating or treatment 5 to limit wetting and impede corrosion and build-ups.

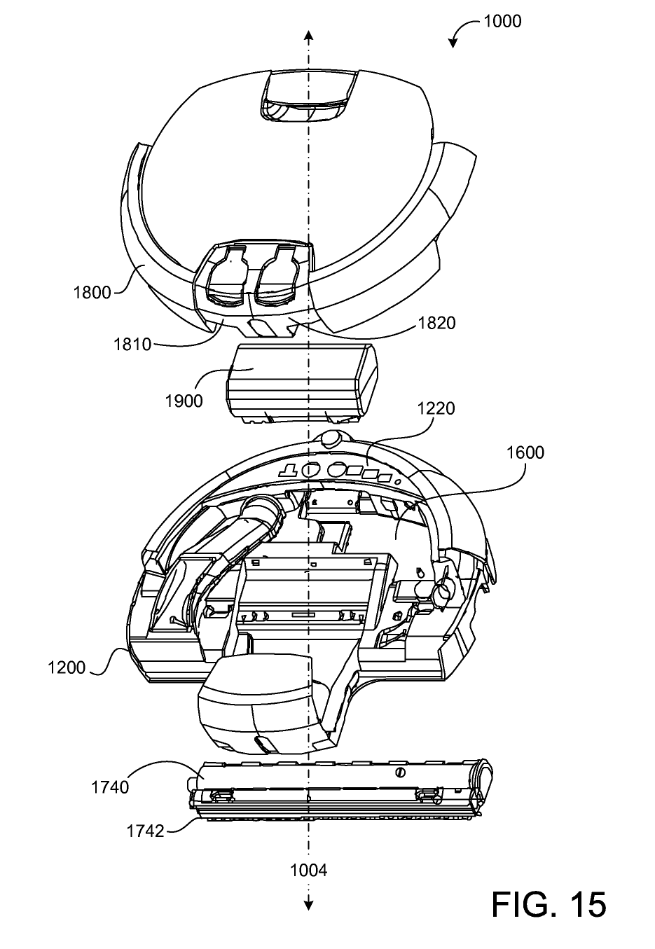

Referring to FIGS. 14-16, the robot 1000 includes a controller 1600 supported by the chassis 1100 and in electrical communication with one or more robot subsystems, such as the battery 1900 for receiving power and the drive system 1500 for issuing drive commands. The super-hydrophobic coating or treatment 5 can be applied to the controller 1600 and/or any interconnected subsystems to seal those components from fluid exposure. The controller 1600 can be interconnected for two-way communication with the one or more robot subsystems. The interconnection of the robot subsystems is provided via a network of wires and or conductive elements, e.g., conductive paths formed on an integrated printed circuit board or the like. The controller 1600 at least includes a programmable or preprogrammed digital data processor, e.g., a microprocessor, for performing program steps, algorithms and/or mathematical and logical operations as may be required. Moreover, the controller 1600 includes digital data memory in communication with the data processor for storing program steps and other digital data therein. The controller 1600 also includes one or more clock elements for generating timing signals as may be required.

Referring again to FIG. 12, the robot 1000 may include one or more interface modules 1210. Each interface module 1210 can be attached to the robot chassis 1100 to provide an interconnecting element or port for interconnecting with one or more external devices. Interconnecting elements and ports may be accessible on an external surface of the robot body 1200. As a result, all or portions of the interface modules may receive the super-hydrophobic coating or treatment 5 to prevent or impede infiltration of fluid into electrical components of the robot 1000. The controller 1600 may also interface with the interface modules 1210 to control the interaction of the robot 1000 with an external device. In particular, one interface module 1210a can be provided for charging the battery 1900 via an external power supply or power source such as a conventional AC or DC power outlet.

Another interface module 1210b may be configured for one or two way communications over a wireless network and further interface module elements may be configured to interface with one or more mechanical devices to exchange liquids and loose particulates therewith, e.g., for filling a cleaning fluid reservoir or for draining or emptying a waste material container. Accordingly, the interface module 1210 may comprise a plurality of interface ports and connecting elements for interfacing with active external elements for exchanging operating commands, digital data and other electrical signals therewith. The interface module 1210 may further interface with one or more mechanical devices for exchanging liquid and or solid materials therewith. Active external devices for interfacing with the robot 1000 may include, but are not limited to, a floor standing docking station, a hand held remote control device, a local or remote computer, a modem, a portable memory device for exchanging code and or data with the robot and a network interface for interfacing the robot 1000 with any device connected to the network. In addition, the interface module 1210 may include passive elements such as hooks and or latching mechanisms for attaching the robot 1000 to a wall for storage or for attaching the robot to a carrying case or the like.

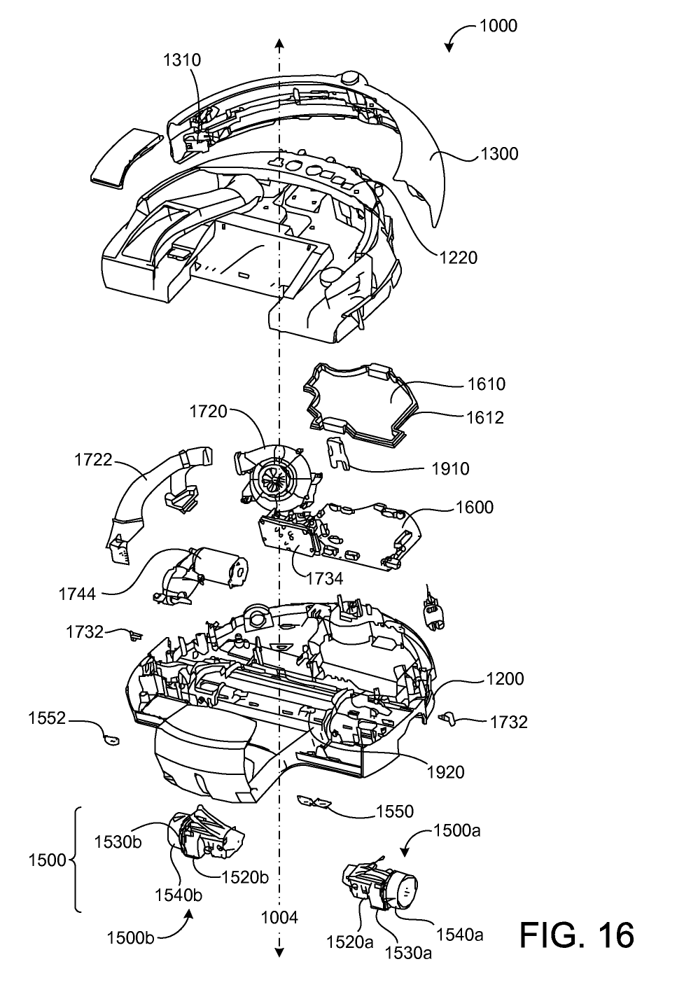

Referring to FIGS. 15 and 16, the robot 100 may include a user interface 1220, which provides one or more user input interfaces that generate an electrical signal in response to a user input and communicate the signal to the controller 1600. The super-hydrophobic coating or treatment 5 can be applied to the user interface 1220 to repel fluids (e.g., from a user's hand or a facet when filling the supply tank 1810). In some examples, a user may enter commands via a hand held remote control device, a programmable computer or other programmable device or via voice commands. A user may input user commands to initiate actions such as power on/off, start, stop or to change a cleaning mode, set a cleaning duration, program cleaning parameters such as start time and duration, and or many other user initiated commands. User input commands, functions, and components contemplated for use with the present invention are specifically described in U.S. patent application Ser. No. 11/166,891, by Dubrovsky et al., filed on Jun. 24, 2005, entitled “Remote Control Scheduler and Method for Autonomous Robotic Device,” the entire disclosure of which is hereby incorporated by reference it its entirety.

The robot 100 may include a plurality of sensors in communication with the controller 1600 and/or integrated with robot subsystems for sensing external conditions and/or for sensing internal conditions. In response to sensing various conditions, the sensors may generate electrical signals and communicate the electrical signals to the controller 1600. Individual sensors may perform such functions as detecting walls and other obstacles, detecting drop offs in the cleaning surface, called cliffs, detecting dirt on the floor, detecting low battery power, detecting an empty cleaning fluid container, detecting a full waste container, measuring or detecting drive wheel velocity distance traveled or slippage, detecting nose wheel rotation or cliff drop off, detecting cleaning system problems such rotating brush stalls or vacuum system clogs, detecting inefficient cleaning, cleaning surface type, system status, temperature, and many other conditions. Any of these sensors, when incorporated onto the robot 100, can receive the super-hydrophobic coating or treatment 5 to seal them from fluid exposure and/or other environmental factors. Several aspects of sensors for sensing external elements and conditions are specifically described in U.S. Pat. No. 6,594,844, by Jones, entitled “Robot Obstacle Detection System,” and U.S. patent application Ser. No. 11/166,986, by Casey et al., filed on Jun. 24, 2005, entitled “Obstacle Following Sensor Scheme for a Mobile Robot,” the entire disclosures of which are hereby incorporated by reference it their entireties.

Referring again to FIG. 16, much of the volume of the robot 1000 is occupied by fluid brushing, spinning, spraying, and blowing devices. As a result, fluid and/or foam may penetrate most parts of the robot 1000 at one time or another. At most, the control and sensor electronics will be a few inches from the nearest fluid. Accordingly, some or all of the electrical components or components adjacent or encapsulating the electrical components may be sealed from fluid exposure by receiving the super-hydrophobic coating or treatment 5. For example, in order to protect the controller 1600 from fluid exposure, controller 1600 may receive the super-hydrophobic coating 5. Moreover, the robot 1000 may include a board gasket seal 1612 that lines the edge of the controller board 1600 and matches up with a mating controller cover 1610 to protect the controller 1600. The board gasket seal 1612 (and/or any other seals on the robot 1000) may be treated with the super-hydrophobic coating 5 to improve leakage resistance under poor compression conditions and protect against corrosion. The controller cover 1610 may be a water resistant or waterproof housing having at least JIS grade 3 (mild spray) water/fluid resistance, but grade 5 (strong spray) and grade 7 (temporary immersion) can be used as well. After fastening the controller cover 1610 over the controller 1600 (e.g., onto the chassis 110 using fasteners, welding, caulking, adhesives, etc.), the controller cover 1610 and optionally an immediate vicinity can receive the super-hydrophobic coating or treatment 5.

Any or all electrical components of the robot 1000 and optionally intermediate structures containing the electrical components can receive the super-hydrophobic coating or treatment 5 to waterproof or protect against fluid exposure, so as to prevent short circuits and/or corrosion. For example, many sensor elements have a local small circuit board, sometimes with a local microprocessor and/or A/D converter, and these components are often sensitive to fluids and corrosion. In addition, exposed electrical connections and terminals of sensors, motors, or communication lines can be sealed as well. Any and all electrical or electronic elements defined herein as a circuit board, PCB, detector, sensor, etc., are candidates for sealing by receiving the super-hydrophobic coating or treatment 5.

Referring again to FIG. 16, a bump sensor 1310 disposed on the bumper 1300 and in communication with the controller 1600 for detecting a bump event, the air mover 1720, the brush motor 1744, the pump 1734, a charging plug PCB 1910 for receiving a battery charging cord, and an internal portion of a battery contact blade 1920 for contact to the battery 1900 as it is placed into the robot body 1200 are all exemplary components for receiving the super-hydrophobic coating or treatment 5 to safe guard against fluid exposure.

Other electrical components that may receive the super-hydrophobic coating or treatment 5 include, but are not limited to, the drive motors 1520a, 1520b of the respective right and left wheel modules 1500a, 1500b, a stasis circuit board 1550 bearing IR “stasis” sensors and components (i.e., that detect when the front wheel does not rotate along with the driven wheels, indicating the robot may be stuck), and a reed switch PCB 1552 for detecting a wheel drop state (e.g., when the corresponding drive wheel 1540a, 1540b moves vertically downward upon encountering a cliff).

In some implementations, the robot 100, 1000 can receive the super-hydrophobic coating or treatment 5 at various stages of assembly and/or upon completion. For example, individual components of the robot 100, 1000, such as the base plate 120, chassis 110, 1100, body 1200, bumper 130, 1300, user interface 140, 1400, wheel modules 150a, 150b, 1500a, 1500b controller 246, 160, 1600, etc. can receive the super-hydrophobic coating or treatment 5 (e.g., by dipping, spraying, etc.) before assembly of the robot 100, 1000. In additional examples, the partially assembled and/or fully assembled robot 100, 1000 receives the super-hydrophobic coating or treatment 5 (e.g., by dipping, spraying, etc.).

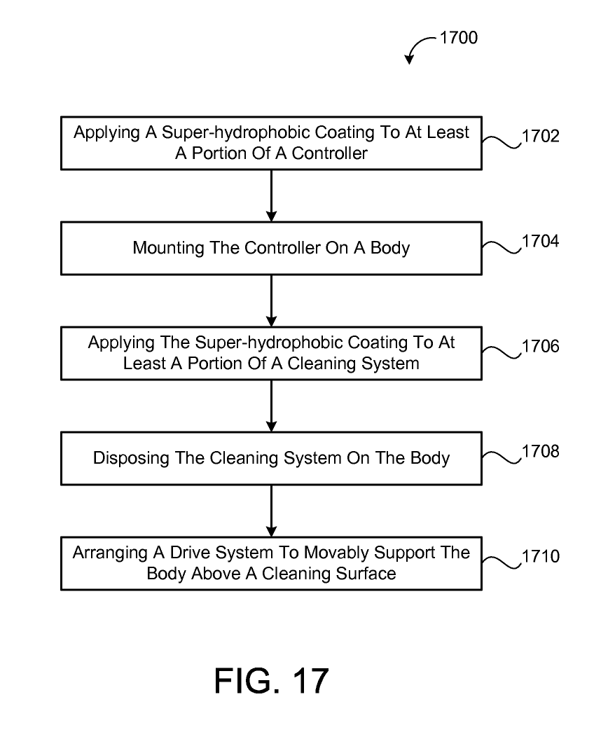

FIG. 17 provides an exemplary arrangement of operations for making a mobile robot 100, 1000. With additional reference to FIGS. 7 and 13-16, a method of making the mobile robot 100, 1000 includes applying 1702a super-hydrophobic coating 5 to at least a portion of a controller 160, 1600, mounting 1704 the controller 160, 1600 on a chassis or body 110, 1100, 1200, applying 1706 the super-hydrophobic coating 5 to at least a portion of a cleaning system 170, 1700, disposing 1708 the cleaning system 170, 1700 on the body 110, 1100, 1200, and arranging 1710a drive system 150, 1500 to movably support the body 110, 1100, 1200 above a cleaning surface 10.

The method may include disposing a right drive wheel module 150a, 1500a substantially opposite a left drive module 150a, 1500a with respect to a forward drive direction F. Each drive wheel module 150a, 150b, 1500a, 1500b includes a drive wheel 154a, 154b, 1540a, 1540b driven by a drive motor 152a, 152b, 1520a, 1520b. The method may include applying the super-hydrophobic coating 5 to at least one of the drive wheel 154a, 154b, 1540a, 1540b and the drive motor 152a, 152b, 1520a, 1520b of each drive wheel module 150a, 150b, 1500a, 1500b.

In some examples, the method includes disposing a cleaning element on the body 110, 1100, 1200 for engagement with the cleaning surface 10. The cleaning element extends across at least a portion of a width W of the mobile robot 100, 1000 and receives the super-hydrophobic coating 5. Moreover, the cleaning element includes at least one of a driven brush 1742, a smearing element 126, 128, and a compliant blade 126, 128, 1718a, 1718b.

The method may include disposing a vacuum assembly 190, 200, 1720 on the body 110, 1100, 1200, where at least a portion of the vacuum assembly 190, 200, 1720 receives the super-hydrophobic coating 5. A squeegee 180 treated with the super-hydrophobic coating 5 can be disposed on the body 110 as well. The squeegee 180 extends across a cleaning width W of the mobile robot 100 and is arranged for movable engagement with the cleaning surface 10 for collecting and directing liquid on the cleaning surface 10 toward suction apertures 182 defined by the squeegee 180 and in fluid communication with the vacuum assembly 190.

In some implementations, the method includes disposing a liquid applicator on the body 110, 1100, 1200. The liquid applicator 122, 1730 is configured to spray a liquid onto the cleaning surface 10. The method also includes disposing a supply volume 172, 1810 in fluid communication with the liquid applicator 122, 1730, disposing a liquid collector B, 180, 190, 1740 rearward of the liquid applicator 122, 1730 with respect to a forward drive direction F, and disposing a waste volume 174, 1820 in fluid communication with the liquid collector B, 180, 190, 1740. At least one of the liquid applicator 122, 1730, the supply volume 172, 1810, the liquid collector B, 180, 190, 1740, and the waste volume 174, 1820 receives the super-hydrophobic coating 5. Moreover, at least a portion of the body 110, 120, 1100, 1200 and/or internal and/or external surfaces of the supply and waste volumes 172, 174, 1810, 1820 may receive the super-hydrophobic coating 5. The liquid applicator 122, 1730 may include at least one nozzle 124, 1732 arranged for spraying liquid onto the cleaning surface 10 and a pump 125, 1734 in fluid communication with the at least one nozzle 124, 1732. At least one of the at least one nozzle 124, 1732 and the pump 125, 1734 may receive the super-hydrophobic coating 5.

The method may include disposing a sensor system in communication with the controller 160, 1600. The sensor system includes at least one sensor communicating a corresponding electric signal to the controller 160, 1600 and at least a portion of the sensor system is treated with the super-hydrophobic coating 5. At least one sensor provides an electric signal corresponding to at least one of an obstacle detection, a low battery power detection, a drive wheel drop event, a cliff detection, a dirty floor detection, an empty supply fluid container detection, a full waste container detection, a drive wheel velocity, a travel distance, a cleaning system error, a cleaning surface type, a stasis detection, and a temperature.

A number of implementations have been described. Nevertheless, it will be understood that various modifications may be made without departing from the spirit and scope of the disclosure. Accordingly, other implementations are within the scope of the following claims.

What is claimed is:

1. A mobile robot comprising:
a body;
a drive system movably supporting the body above a cleaning surface;
a cleaning system arranged to clean the cleaning surface;
a controller in communication with at least one of the drive system and the cleaning system; and
a super-hydrophobic coating applied to at least one of the drive system, the cleaning system, and the controller.

2. The mobile robot of claim 1, wherein a water contact angle of the super-hydrophobic coating is greater than or equal to 150 degrees.

3. The mobile robot of claim 1, wherein the super-hydrophobic coating comprises nanoparticles between 10 μm-100 nm in size.

4. The mobile robot of claim 3, wherein the super-hydrophobic coating comprises a polymeric binder.

5. The mobile robot of claim 4, wherein the polymer binder is prepared from silicone resin and an acrylic polymer.

6. The mobile robot of claim 4, wherein the nanoparticles comprise 20-40% by weight of the composition and the binder comprises 60-80% by weight of the composition.

7. The mobile robot of claim 1, further comprising a battery contact treated with the super-hydrophobic coating and in electrical communication with at least one of the controller and the cleaning system, the battery contact blade configured to receive electrical contact with a battery.

8. The mobile robot of claim 1, wherein the drive system comprises right and left drive wheel modules, each drive wheel module having a drive wheel coupled to a drive motor, at least one of the drive wheel and the drive motor receives the super-hydrophobic coating.

9. The mobile robot of claim 1, wherein the cleaning system comprises a cleaning head engaging the cleaning surface and being treated with the super-hydrophobic coating.

10. The mobile robot of claim 9, wherein the cleaning head comprises at least one of a driven brush, a smearing element, and a compliant blade extending across at least a portion of a width of the mobile robot.

11. The mobile robot of claim 1, wherein the cleaning system comprises:
a vacuum assembly, at least a portion of which receives the super-hydrophobic coating; and
a squeegee treated with the super-hydrophobic coating, the squeegee extending across a cleaning width of the mobile robot and arranged for movable engagement with the cleaning surface for collecting and directing liquid on the cleaning surface toward suction apertures defined by the squeegee and in fluid communication with the vacuum assembly.

12. The mobile robot of claim 1, wherein the cleaning system comprises:
a liquid applicator configured to spray a liquid onto the cleaning surface;
a supply volume in fluid communication with the liquid applicator;
a liquid collector disposed rearward of the liquid applicator with respect to a forward drive direction; and
a waste volume in fluid communication with the liquid collector;
wherein at least one of the liquid applicator, the supply volume, the liquid collector, and the waste volume receives the super-hydrophobic coating.

13. The mobile robot of claim 12, wherein internal surfaces of the supply and waste volumes receive the super-hydrophobic coating.

14. The mobile robot of claim 12, wherein the liquid applicator comprises:
at least one nozzle arranged for spraying liquid onto the cleaning surface; and
a pump in fluid communication with the at least one nozzle;
wherein at least one of the at least one nozzle and the pump receives the super-hydrophobic coating.

15. The mobile robot of claim 12, wherein the liquid collector comprises:
a vacuum assembly, at least a portion of which receives the super-hydrophobic coating; and
a squeegee treated with the super-hydrophobic coating, the squeegee extending across a cleaning width of the mobile robot and arranged for movable engagement with the cleaning surface for collecting and directing liquid on the cleaning surface toward suction apertures defined by the squeegee and in fluid communication with the vacuum assembly.

16. The mobile robot of claim 15, wherein internal surfaces of passageways of the vacuum assembly receive the super-hydrophobic coating.

17. The mobile robot of claim 1, wherein external surfaces of the mobile robot receive the super-hydrophobic coating.

18. The mobile robot of claim 1, further comprising a sensor system having at least one sensor communicating a corresponding electric signal to the controller, at least a portion of the sensor system being treated with the super-hydrophobic coating.

19. The mobile robot of claim 18, wherein the at least one sensor provides an electric signal corresponding to at least one of an obstacle detection, a low battery power detection, a drive wheel drop event, a cliff detection, a dirty floor detection, an empty supply fluid container detection, a full waste container detection, a drive wheel velocity, a travel distance, a cleaning system error, a cleaning surface type, a stasis detection, and a temperature.

20. The mobile robot of claim 1, further comprises a user interface in communication with the controller, the user interface receiving the super-hydrophobic coating.

21. A mobile robot comprising:
a body;
a drive system movably supporting the body above a cleaning surface;
a cleaning system arranged to clean the cleaning surface, the cleaning system comprising:
a vacuum assembly having a collection region engaging the cleaning surface and a suction region in fluid communication with the collection region, the suction region suctions waste from the cleaning surface through the collection region;
a collection volume in fluid communication with the vacuum assembly for collecting waste removed by the vacuum assembly;
a supply volume carried by the body and configured to hold a cleaning liquid;
a liquid applicator in fluid communication with the supply volume, the liquid applicator dispenses the cleaning liquid onto the cleaning surface; and
a wetting element engaging the cleaning surface to distribute the cleaning liquid along at least a portion of the cleaning surface when the robot is driven in a forward direction;
a controller in communication with at least one of the drive system and the cleaning system; and
a super-hydrophobic coating applied to at least one of the drive system, the cleaning system, and the controller.

22. The mobile robot of claim 21, wherein a water contact angle of the super-hydrophobic coating is greater than or equal to 150 degrees.

23. The mobile robot of claim 21, wherein the super-hydrophobic coating comprises nanoparticles between 10 μm-100 nm in size.

24. The mobile robot of claim 23, wherein the super-hydrophobic coating comprises a polymeric binder.

25. The mobile robot of claim 24, wherein the polymer binder is prepared from silicone resin and an acrylic polymer.

26. The mobile robot of claim 24, wherein, wherein the nanoparticles comprise 20-40% by weight of the composition and the binder comprises 60-80% by weight of the composition.

27. The mobile robot of claim 21, further comprising a battery contact treated with the super-hydrophobic coating and in electrical communication with at least one of the controller and the cleaning system, the battery contact blade configured to receive electrical contact with a battery.

28. The mobile robot of claim 21, wherein the drive system comprises right and left drive wheel modules, each drive wheel module having a drive wheel coupled to a drive motor, at least one of the drive wheel and the drive motor receives the super-hydrophobic coating.

29. The mobile robot of claim 21, wherein at least one of the vacuum assembly, the collection volume, the supply volume, the liquid applicator, and the wetting element receive the super-hydrophobic coating.

30. The mobile robot of claim 21, wherein internal surfaces of passageways of the vacuum assembly receive the super-hydrophobic coating.

31. The mobile robot of claim 21, wherein internal surfaces of the supply and waste volumes receive the super-hydrophobic coating.

32. The mobile robot of claim 21, wherein the collection region of the vacuum assembly comprises a squeegee treated with the super-hydrophobic coating, the squeegee extending across a cleaning width of the mobile robot and arranged for movable engagement with the cleaning surface for collecting and directing liquid on the cleaning surface toward suction apertures defined by the squeegee.

33. The mobile robot of claim 21, wherein the body is treated with the super-hydrophobic coating.

34. The mobile robot of claim 33, wherein a bottom surface of the body exposed to the cleaning surfaces is treated with the super-hydrophobic coating.

35. The mobile robot of claim 21, further comprising a sensor system having at least one sensor communicating a corresponding electric signal to the controller, at least a portion of the sensor system being treated with the super-hydrophobic coating.

36. The mobile robot of claim 35, wherein the at least one sensor provides an electric signal corresponding to at least one of an obstacle detection, a low battery power detection, a drive wheel drop event, a cliff detection, a dirty floor detection, an empty supply fluid container detection, a full waste container detection, a drive wheel velocity, a travel distance, a cleaning system error, a cleaning surface type, a stasis detection, and a temperature.

37. The mobile robot of claim 35, wherein the sensor system comprises wire leads and/or wiring treated with the super-hydrophobic coating.

38. The mobile robot of claim 21, further comprises a user interface in communication with the controller, the user interface receiving the super-hydrophobic coating.

39. The mobile robot of claim 21, further comprises a gasket for sealing at least one of the body, the controller, the drive system, and the cleaning system, the gasket receiving the super-hydrophobic coating.

40. A method of making a mobile robot, the method comprising:
applying a super-hydrophobic coating to at least a portion of a controller;
mounting the controller on a body;
applying the super-hydrophobic coating to at least a portion of a cleaning system;
disposing the cleaning system on the body; and
arranging a drive system to movably support the body above a cleaning surface.

41. The method of claim 40, wherein a water contact angle of the super-hydrophobic coating is greater than or equal to 150 degrees.

42. The method of claim 40, wherein the super-hydrophobic coating comprises nanoparticles between 10 μm-100 nm in size.

43. The method of claim 40, wherein the super-hydrophobic coating comprises a polymeric binder.

44. The method of claim 43, wherein the polymer binder is prepared from silicone resin and an acrylic polymer.

45. The method of claim 43, wherein, wherein the nanoparticles comprise 20-40% by weight of the composition and the binder comprises 60-80% by weight of the composition.

46. The method of claim 40, further comprising disposing a right drive wheel module substantially opposite a left drive module with respect to a forward drive direction, each drive wheel module comprising a drive wheel driven by a drive motor.

47. The method of claim 46, further comprising applying the super-hydrophobic coating to at least one of the drive wheel and the drive motor of each drive wheel module.

48. The method of claim 40, further comprising disposing a cleaning element on the body for engagement with the cleaning surface, the cleaning element extending across at least a portion of a width of the mobile robot and receiving the super-hydrophobic coating, the cleaning element comprising at least one of a driven brush, a smearing element, and a compliant blade.

49. The method of claim 40, further comprising disposing a vacuum assembly on the body, at least a portion of the vacuum assembly receiving the super-hydrophobic coating.

50. The method of claim 49, further comprising disposing a squeegee treated with the super-hydrophobic coating on the body, the squeegee extending across a cleaning width of the mobile robot and arranged for movable engagement with the cleaning surface for collecting and directing liquid on the cleaning surface toward suction apertures defined by the squeegee and in fluid communication with the vacuum assembly.

51. The method of claim 49, further comprising:
disposing a liquid applicator on the body, the liquid applicator configured to spray a liquid onto the cleaning surface;
disposing a supply volume in fluid communication with the liquid applicator;
disposing a liquid collector rearward of the liquid applicator with respect to a forward drive direction; and
disposing a waste volume in fluid communication with the liquid collector;
wherein at least one of the liquid applicator, the supply volume, the liquid collector, and the waste volume receives the super-hydrophobic coating.

52. The method of claim 51, wherein internal surfaces of the supply and waste volumes receive the super-hydrophobic coating.

53. The method of claim 51, wherein the liquid applicator comprises:
at least one nozzle arranged for spraying liquid onto the cleaning surface; and
a pump in fluid communication with the at least one nozzle;
wherein at least one of the at least one nozzle and the pump receives the super-hydrophobic coating.

54. The method of claim 40, further comprising disposing a sensor system in communication with the controller, the sensor system having at least one sensor communicating a corresponding electric signal to the controller, at least a portion of the sensor system being treated with the super-hydrophobic coating.

55. The method of claim 54, wherein the at least one sensor provides an electric signal corresponding to at least one of an obstacle detection, a low battery power detection, a drive wheel drop event, a cliff detection, a dirty floor detection, an empty supply fluid container detection, a full waste container detection, a drive wheel velocity, a travel distance, a cleaning system error, a cleaning surface type, a stasis detection, and a temperature.

56. The method of claim 40, further comprising applying a super-hydrophobic coating to at least a portion of the body.
